(19) United States
(12) Patent Application Publication
(10) Pub. No.: US 2025/0378563 A1
(43) Pub. Date: Dec. 11, 2025

(54) OBJECT DETECTION AND TRACKING WITH A LOCATION PRIOR

(71) Applicant: QUALCOMM Incorporated, San Diego, CA (US)

(72) Inventors: Shuangjun LIU, San Diego, CA (US); Dashan GAO, San Diego, CA (US); Mithun Kumar RANGANATH, Surrey (CA); Leulseged Tesfaye ALEMU, San Diego, CA (US)

(21) Appl. No.: 18/737,690

(22) Filed: Jun. 7, 2024

(51) Int. Cl. G06T 7/246; G06T 7/73; G06V 40/10

(52) U.S. Cl. CPC G06T 7/248; G06T 7/74; G06V 40/10; G06T 2207/20076; G06T 2207/30196

(57) ABSTRACT

Techniques are described for object detection. For example, a computing device can: determine, based on a first image of a scene obtained from a camera with a first view of the scene, a first probability map including probabilities of object(s) being located at locations within the scene; determine a location of an item associated with each object in the first image; map the item from the first view to a second view to produce a prior probability map associated with the second view. The computing device can obtain, from the camera/another camera with a second view of the scene, a second image of the scene; determine, based on the second image, a second probability map including additional probabilities of the object(s) being located at the locations; blend the second probability map with the prior probability map; detect, based on the blended probability map, the object(s) of the scene.

### FIELD

The present disclosure generally relates to object detection. For example, aspects of the present disclosure relate to object detection and tracking with a location prior.

### BACKGROUND

Many devices and systems allow a scene to be captured by generating images (or frames) and/or video data (including multiple frames) of the scene. For example, a camera or a device including a camera can capture a sequence of frames of a scene (e.g., a video of a scene). In some cases, the sequence of frames can be processed for performing one or more functions, can be output for display, can be output for processing and/or consumption by other devices, among other uses.

Object detection can be used to identify an object (e.g., from a digital image or a video frame of a video clip). In some cases, object tracking can be performed to track the object over time (e.g., over a number of frames). Object detection and/or tracking can be used in different fields, including transportation, video analytics, security systems, robotics, aviation, home usage, among many others.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, apparatuses, methods and computer-readable media for object detection and tracking with a location prior. According to at least one example, an apparatus for object detection is provided. The apparatus includes at least one memory and at least one processor coupled to the at least one memory and configured to: obtain, from a camera with a first view of a scene including one or more objects, a first image of the scene; determine, based on the first image, a first probability map including first probabilities of the one or more objects being located at locations within the scene; determine, based on the first image, a location of an item associated with each object of the one or more objects; map the item associated with each object of the one or more objects from the first view to a second view to produce a prior probability map associated with the second view; obtain, from the camera or another camera with the second view of the scene, a second image of the scene; determine, based on the second image, a second probability map including second probabilities of the one or more objects being located at the locations within the scene; blend the second probability map with the prior probability map to produce a blended probability map; and detect, based on the blended probability map, the one or more objects of the scene.

In some aspects, a method for object detection is provided. The method includes: obtaining, by a camera with a first view of a scene including one or more objects, a first image of the scene; determining, based on the first image, a first probability map including first probabilities of the one or more objects being located at locations within the scene; determining, based on the first image, a location of an item associated with each object of the one or more objects; mapping the item associated with each object of the one or more objects from the first view to a second view to produce a prior probability map associated with the second view; obtaining, by the camera or another camera with the second view of the scene, a second image of the scene; determining, based on the second image, a second probability map including second probabilities of the one or more objects being located at the locations within the scene; blending the second probability map with the prior probability map to produce a blended probability map; and detecting, based on the blended probability map, the one or more objects of the scene.

In some aspects, a non-transitory computer-readable medium is provided having stored thereon instructions that, when executed by at least one processor, cause the at least one processor to: obtain, from a camera with a first view of a scene including one or more objects, a first image of the scene; determine, based on the first image, a first probability map including first probabilities of the one or more objects being located at locations within the scene; determine, based on the first image, a location of an item associated with each object of the one or more objects; map the item associated with each object of the one or more objects from the first view to a second view to produce a prior probability map associated with the second view; obtain, from the camera or another camera with the second view of the scene, a second image of the scene; determine, based on the second image, a second probability map including second probabilities of the one or more objects being located at the locations within the scene; blend the second probability map with the prior probability map to produce a blended probability map; and detect, based on the blended probability map, the one or more objects of the scene.

In some aspects, an apparatus for object detection is provided. The apparatus includes: means for obtaining, from a camera with a first view of a scene including one or more objects, a first image of the scene; means for determining, based on the first image, a first probability map including first probabilities of the one or more objects being located at locations within the scene; means for determining, based on the first image, a location of an item associated with each object of the one or more objects; means for mapping the item associated with each object of the one or more objects from the first view to a second view to produce a prior probability map associated with the second view; means for obtaining, from the camera or another camera with the second view of the scene, a second image of the scene; means for determining, based on the second image, a second probability map including second probabilities of the one or more objects being located at the locations within the scene; means for blending the second probability map with the prior probability map to produce a blended probability map; and means for detecting, based on the blended probability map, the one or more objects of the scene.

In some aspects, each of the apparatuses described above is, can be part of, or can include a mobile device, a smart or connected device, a camera system, and/or an extended reality (XR) device (e.g., a virtual reality (VR) device, an augmented reality (AR) device, or a mixed reality (MR) device). In some examples, the apparatuses can include or be part of a vehicle, a mobile device (e.g., a mobile telephone or so-called “smart phone” or other mobile device), a wearable device, a personal computer, a laptop computer, a tablet computer, a server computer, a robotics device or system, an aviation system, or other device. In some aspects, the apparatus includes an image sensor (e.g., a camera) or multiple image sensors (e.g., multiple cameras) for capturing one or more images. In some aspects, the apparatus includes one or more displays for displaying one or more images, notifications, and/or other displayable data. In some aspects, the apparatus includes one or more speakers, one or more light-emitting devices, and/or one or more microphones. In some aspects, the apparatuses described above can include one or more sensors. In some cases, the one or more sensors can be used for determining a location of the apparatuses, a state of the apparatuses (e.g., a tracking state, an operating state, a temperature, a humidity level, and/or other state), and/or for other purposes.

Some aspects include a device having a processor configured to perform one or more operations of any of the methods summarized above. Further aspects include processing devices for use in a device configured with processor-executable instructions to perform operations of any of the methods summarized above. Further aspects include a non-transitory processor-readable storage medium having stored thereon processor-executable instructions configured to cause a processor of a device to perform operations of any of the methods summarized above. Further aspects include a device having means for performing functions of any of the methods summarized above.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims. The foregoing, together with other features and aspects, will become more apparent upon referring to the following specification, claims, and accompanying drawings.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The preceding, together with other features and embodiments, will become more apparent upon referring to the following specification, claims, and accompanying drawings.

### BRIEF DESCRIPTION OF THE DRAWINGS

Illustrative aspects of the present application are described in detail below with reference to the following figures:

FIG. 1 is a block diagram illustrating an architecture of an image capture and processing system, in accordance with aspects of the present disclosure.

FIG. 2 is a diagram illustrating an architecture of an example system, in accordance with some aspects of the disclosure.

FIG. 3 is a diagram illustrating examples images with missed detections of targets that are occluded, in accordance with some aspects of the disclosure.

FIG. 4 is a diagram illustrating an example of an object detection pipeline, in accordance with some aspects of the disclosure.

FIG. 5 is a diagram illustrating an example of a process for object detection and tracking with a location prior, in accordance with some aspects of the disclosure.

FIG. 6 is a diagram illustrating an example of a prior application method for object detection and tracking, where the method applies prior probability maps to two views, in accordance with some aspects of the disclosure.

FIG. 7 is a diagram illustrating an example of a prior application method for object detection and tracking, where the method applies a position prior to a single view, in accordance with some aspects of the disclosure.

FIG. 8 is a diagram illustrating an example of a position prior generation method for object detection and tracking, where the method generates a prior map from a current frame, in accordance with some aspects of the disclosure.

FIG. 9 is a diagram illustrating an example of a position prior generation method for object detection and tracking, where the method generates a prior map from a previous frame, in accordance with some aspects of the disclosure.

FIG. 10 is a diagram illustrating an example of a position prior generation method for object detection and tracking, where the method generates a prior map from a multi-camera tracker predicted location, in accordance with some aspects of the disclosure.

FIG. 11 is a diagram illustrating example images of a scene, where an image with a non-occluded view of targets is used as a prior, in accordance with some aspects of the disclosure.

FIG. 12 is a diagram illustrating an example images and probability maps showing a process for object detecting using a prior application method, in accordance with some aspects of the disclosure.

FIG. 13 is a flow diagram illustrating an example of a process for object detection, in accordance with aspects of the present disclosure.

FIG. 14 is a diagram illustrating an example of a system for implementing certain aspects described herein.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein can be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the spirit and scope of the application as set forth in the appended claims.

The terms “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

As previously mentioned, object detection may be used to identify an object (e.g., from a digital image or a video frame of a video clip). In some cases, object tracking may be performed to track the object over time (e.g., over a number of frames). Object detection and/or tracking may be used in different fields, such as transportation, video analytics, security systems, robotics, aviation, among many others.

Object detection algorithms often suffer from missed detections of targets (e.g., objects) when the targets are heavily occluded. These missed detections occur because the object detectors mainly depend upon local features of a target within an image, and these local features can be strongly affected when the target is occluded.

Currently, there are existing object detection solutions that can result in a lower number of missed detections. One such solution involves simply lowering the probability detection threshold (e.g., which can be used to determine whether an object has indeed been detected), which can allow for more detections. However, this solution can lead to an increase in false positive detections (e.g., detections of objects that are not actually present in the scene). Another solution involves collecting and annotating additional data in a similar setting (e.g., in a partial view of the object, such as a person, due to the occlusion). However, this solution can result in an increase in cost for the additional data collection and annotations. An additional solution involves deploying a larger object detection model with stronger detection capability for occluded objects. However, a larger object detection model can have a reduced model efficiency as compared to smaller object detection models.

As such, improved systems and techniques for object detection that can result in a lower number of missed detections can be beneficial.

In a multi-camera system, an object occluded in one view is not always occluded in another view, which can yield strong a detection (e.g., a detection with a high probability of an object being actually present within the scene). A detection of an object (e.g., with a high probability of the object being present) in one view of a scene can be employed as prior for another view (e.g., which may have an occluded view of the object).

In one or more aspects, systems, apparatuses, processes (also referred to as methods), and computer-readable media (collectively referred to herein as “systems and techniques”) are described herein for providing object detection and tracking with a location prior. In one or more examples, the systems and techniques utilize a location prior, which can be derived from a view (e.g., a first view) of a scene with a strong detection of one or more objects (e.g., a detection with a high probability), for another view (e.g., a second view) of the scene, which may have a weak detection of the one or more objects (e.g., a detection with a low probability) that may be caused by the one or more objects being occluded within this view (e.g., the second view). The use of a location prior from other camera views (or from a joint tracker) can effectively reduce missed object detections that result from occlusion and, as such, can improve object detection performance and accuracy.

In one or more aspects, during operation of the systems and techniques for object detection, a camera (e.g., of a first device), with a first view of a scene including one or more objects, can obtain a first image of the scene. One or more processors (e.g., of the first device) can determine, based on the first image, a first probability map including first probabilities of the one or more objects being located at locations within the scene. The one or more processors can determine, based on the first image, a location of an item associated with each object of the one or more objects. The one or more processors can map the item associated with each object of the one or more objects from the first view to a second view to produce a prior probability map associated with the second view. The camera or another camera (e.g., of the first device or a second device), with a second view of the scene, can obtain a second image of the scene. One or more processors (e.g., of the first device or the second device) can determine, based on the second image, a second probability map including second probabilities of the one or more objects being located at the locations within the scene. The one or more processors (e.g., of the first device or the second device) can blend the second probability map with the prior probability map to produce a blended probability map. The one or more processors (e.g., of the first device or the second device) can detect, based on the blended probability map, the one or more objects of the scene.

In one or more examples, blending the second probability map with the prior probability map can be based a weighted sum of the second probability map and the prior probability map, a product of the second probability map and the prior probability map, a confidence preserve of the second probability map, or a prior boosting of the prior probability map. In some examples, when the blending is based on the confidence preserve of the second probability map and for each specific pixel on the second probability map, if it has a confidence level greater than or equal to a confidence threshold, the blended probability map can directly employ the value from second probability map. In one or more examples, for each pixel in the probability map, when the blending is based on the confidence preserve of the prior probability map and the second probability map has a confidence level less than the confidence threshold, the blended probability map can include a weighted second probability map. In some examples, when the blending is based on the prior boosting of the prior probability map, the blended probability map can include a sum of the second probability map and a weighted prior probability map.

In some examples, the first image and the second image can be obtained at a same time. In one or more examples, the first image can be obtained at a first time, the second image can be obtained at a second time, and the first time can be prior to the second time.

In one or more examples, mapping the item associated with each object of the one or more objects from the first view to the second view can be based on homography mapping. In some examples, the first probability map and the second probability map can be each a heatmap. In one or more examples, the item associated with each object of the one or more objects can be a foot (e.g., where each object of the one or more objects is a human).

In some examples, the one more processors (e.g., of the first device or the second device) can determine, based on the second image, a location of the item associated with each object of the one or more objects. The one or more processors can map the item associated with each object of the one or more objects from the second view to a first view to produce another prior probability map associated with the first view. The one or more processors can blend the first probability map with the other prior probability map to produce another blended probability map. The one or more processors can detect, based on the other blended probability map, the one or more objects of the scene.

In some aspects, during operation of the systems and techniques for object detection, a tracker (e.g., of a device), with a first view of a scene including one or more objects, can obtain a first probability map including first probabilities of the one or more objects being located at locations within the scene at a future time. One or more processors (e.g., of the device) can determine, based on the first probability map, a location of an item associated with each object of the one or more objects. A camera (e.g., of the device), with the first view of the scene, can obtain an image of the scene at a current time. The one or more processors can determine, based on the image, a second probability map including second probabilities of the one or more objects being located at the locations within the scene at the current time. The one or more processors can blend the second probability map with the first probability map to produce a blended probability map. The one or more processors can detect, based on the blended probability map, the one or more objects of the scene.

In one or more aspects, the systems and techniques can be employed in a general form for any collaborative object detection application in distributed cameras. The systems and techniques can be utilized for a number of different applications including, but not limited to, usage with multiple static cameras for surveillance, usage within a multi-robot system, and a usage within a scenario having an agent with a blocked viewpoint. These different applications can benefit by employing the systems and techniques for detection of all (or at least most) items (e.g., objects) that are present within a scene. In one or more examples, the systems and techniques can be employed for automotive self-driving applications with inter-agent communication to enhance the single agent recognition capability, such as to be able to detect an occluded pedestrian, which can improve traffic safety.

Additional aspects of the present disclosure are described in more detail below.

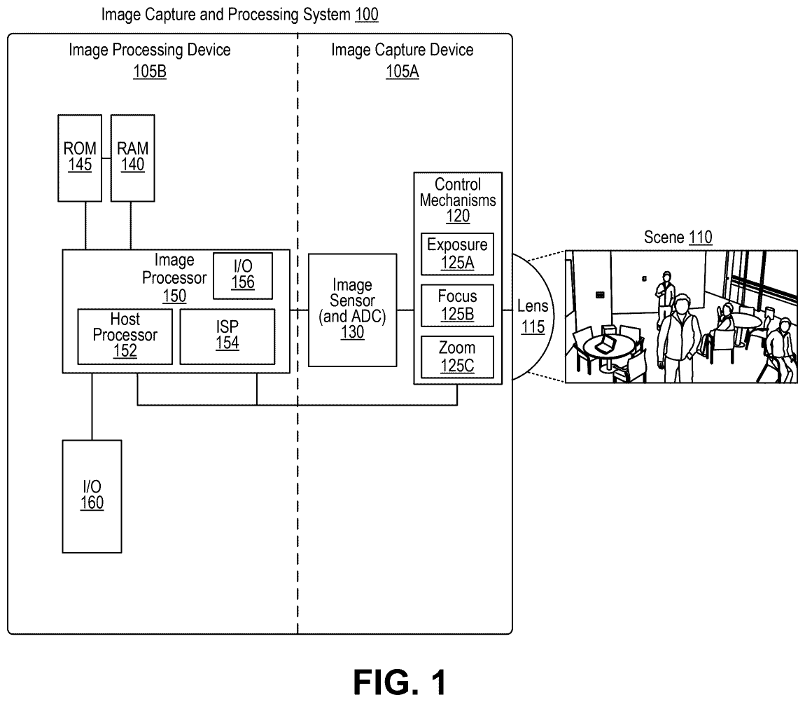

FIG. 1 is a block diagram illustrating an architecture of an image capture and processing system 100. The image capture and processing system 100 includes various components that are used to capture and process images of scenes (e.g., an image of a scene 110). The image capture and processing system 100 can capture standalone images (or photographs) and/or can capture videos that include multiple images (or video frames) in a particular sequence. In some cases, the lens 115 and image sensor 130 can be associated with an optical axis. In one illustrative example, the photosensitive area of the image sensor 130 (e.g., the photodiodes) and the lens 115 can both be centered on the optical axis. A lens 115 of the image capture and processing system 100 faces a scene 110 and receives light from the scene 110. The lens 115 bends incoming light from the scene toward the image sensor 130. The light received by the lens 115 passes through an aperture. In some cases, the aperture (e.g., the aperture size) is controlled by one or more control mechanisms 120 and is received by an image sensor 130. In some cases, the aperture can have a fixed size.

The one or more control mechanisms 120 may control exposure, focus, and/or zoom based on information from the image sensor 130 and/or based on information from the image processor 150. The one or more control mechanisms 120 may include multiple mechanisms and components; for instance, the control mechanisms 120 may include one or more exposure control mechanisms 125A, one or more focus control mechanisms 125B, and/or one or more zoom control mechanisms 125C. The one or more control mechanisms 120 may also include additional control mechanisms besides those that are illustrated, such as control mechanisms controlling analog gain, flash, HDR, depth of field, and/or other image capture properties.

The focus control mechanism 125B of the control mechanisms 120 can obtain a focus setting. In some examples, focus control mechanism 125B store the focus setting in a memory register. Based on the focus setting, the focus control mechanism 125B can adjust the position of the lens 115 relative to the position of the image sensor 130. For example, based on the focus setting, the focus control mechanism 125B can move the lens 115 closer to the image sensor 130 or farther from the image sensor 130 by actuating a motor or servo (or other lens mechanism), thereby adjusting focus. In some cases, additional lenses may be included in the image capture and processing system 100, such as one or more microlenses over each photodiode of the image sensor 130, which each bend the light received from the lens 115 toward the corresponding photodiode before the light reaches the photodiode. The focus setting may be determined via contrast detection autofocus (CDAF), phase detection autofocus (PDAF), hybrid autofocus (HAF), or some combination thereof. The focus setting may be determined using the control mechanism 120, the image sensor 130, and/or the image processor 150. The focus setting may be referred to as an image capture setting and/or an image processing setting. In some cases, the lens 115 can be fixed relative to the image sensor and focus control mechanism 125B can be omitted without departing from the scope of the present disclosure.

The exposure control mechanism 125A of the control mechanisms 120 can obtain an exposure setting. In some cases, the exposure control mechanism 125A stores the exposure setting in a memory register. Based on this exposure setting, the exposure control mechanism 125A can control a size of the aperture (e.g., aperture size or f/stop), a duration of time for which the aperture is open (e.g., exposure time or shutter speed), a duration of time for which the sensor collects light (e.g., exposure time or electronic shutter speed), a sensitivity of the image sensor 130 (e.g., ISO speed or film speed), analog gain applied by the image sensor 130, or any combination thereof. The exposure setting may be referred to as an image capture setting and/or an image processing setting.

The zoom control mechanism 125C of the control mechanisms 120 can obtain a zoom setting. In some examples, the zoom control mechanism 125C stores the zoom setting in a memory register. Based on the zoom setting, the zoom control mechanism 125C can control a focal length of an assembly of lens elements (lens assembly) that includes the lens 115 and one or more additional lenses. For example, the zoom control mechanism 125C can control the focal length of the lens assembly by actuating one or more motors or servos (or other lens mechanism) to move one or more of the lenses relative to one another. The zoom setting may be referred to as an image capture setting and/or an image processing setting. In some examples, the lens assembly may include a parfocal zoom lens or a varifocal zoom lens. In some examples, the lens assembly may include a focusing lens (which can be lens 115 in some cases) that receives the light from the scene 110 first, with the light then passing through an afocal zoom system between the focusing lens (e.g., lens 115) and the image sensor 130 before the light reaches the image sensor 130. The afocal zoom system may, in some cases, include two positive (e.g., converging, convex) lenses of equal or similar focal length (e.g., within a threshold difference of one another) with a negative (e.g., diverging, concave) lens between them. In some cases, the zoom control mechanism 125C moves one or more of the lenses in the afocal zoom system, such as the negative lens and one or both of the positive lenses. In some cases, zoom control mechanism 125C can control the zoom by capturing an image from an image sensor of a plurality of image sensors (e.g., including image sensor 130) with a zoom corresponding to the zoom setting. For example, image processing system 100 can include a wide angle image sensor with a relatively low zoom and a telephoto image sensor with a greater zoom. In some cases, based on the selected zoom setting, the zoom control mechanism 125C can capture images from a corresponding sensor.

The image sensor 130 includes one or more arrays of photodiodes or other photosensitive elements. Each photodiode measures an amount of light that eventually corresponds to a particular pixel in the image produced by the image sensor 130. In some cases, different photodiodes may be covered by different filters. In some cases, different photodiodes can be covered in color filters, and may thus measure light matching the color of the filter covering the photodiode. Various color filter arrays can be used, including a Bayer color filter array, a quad color filter array (also referred to as a quad Bayer color filter array or QCFA), and/or any other color filter array. For instance, Bayer color filters include red color filters, blue color filters, and green color filters, with each pixel of the image generated based on red light data from at least one photodiode covered in a red color filter, blue light data from at least one photodiode covered in a blue color filter, and green light data from at least one photodiode covered in a green color filter.

Returning to FIG. 1, other types of color filters may use yellow, magenta, and/or cyan (also referred to as “emerald”) color filters instead of or in addition to red, blue, and/or green color filters. In some cases, some photodiodes may be configured to measure infrared (IR) light. In some implementations, photodiodes measuring IR light may not be covered by any filter, thus allowing IR photodiodes to measure both visible (e.g., color) and IR light. In some examples, IR photodiodes may be covered by an IR filter, allowing IR light to pass through and blocking light from other parts of the frequency spectrum (e.g., visible light, color). Some image sensors (e.g., image sensor 130) may lack filters (e.g., color, IR, or any other part of the light spectrum) altogether and may instead use different photodiodes throughout the pixel array (in some cases vertically stacked). The different photodiodes throughout the pixel array can have different spectral sensitivity curves, therefore responding to different wavelengths of light. Monochrome image sensors may also lack filters and therefore lack color depth.

In some cases, the image sensor 130 may alternately or additionally include opaque and/or reflective masks that block light from reaching certain photodiodes, or portions of certain photodiodes, at certain times and/or from certain angles. In some cases, opaque and/or reflective masks may be used for phase detection autofocus (PDAF). In some cases, the opaque and/or reflective masks may be used to block portions of the electromagnetic spectrum from reaching the photodiodes of the image sensor (e.g., an IR cut filter, a UV cut filter, a band-pass filter, low-pass filter, high-pass filter, or the like). The image sensor 130 may also include an analog gain amplifier to amplify the analog signals output by the photodiodes and/or an analog to digital converter (ADC) to convert the analog signals output of the photodiodes (and/or amplified by the analog gain amplifier) into digital signals. In some cases, certain components or functions discussed with respect to one or more of the control mechanisms 120 may be included instead or additionally in the image sensor 130. The image sensor 130 may be a charge-coupled device (CCD) sensor, an electron-multiplying CCD (EMCCD) sensor, an active-pixel sensor (APS), a complimentary metal-oxide semiconductor (CMOS), an N-type metal-oxide semiconductor (NMOS), a hybrid CCD/CMOS sensor (e.g., sCMOS), or some other combination thereof.

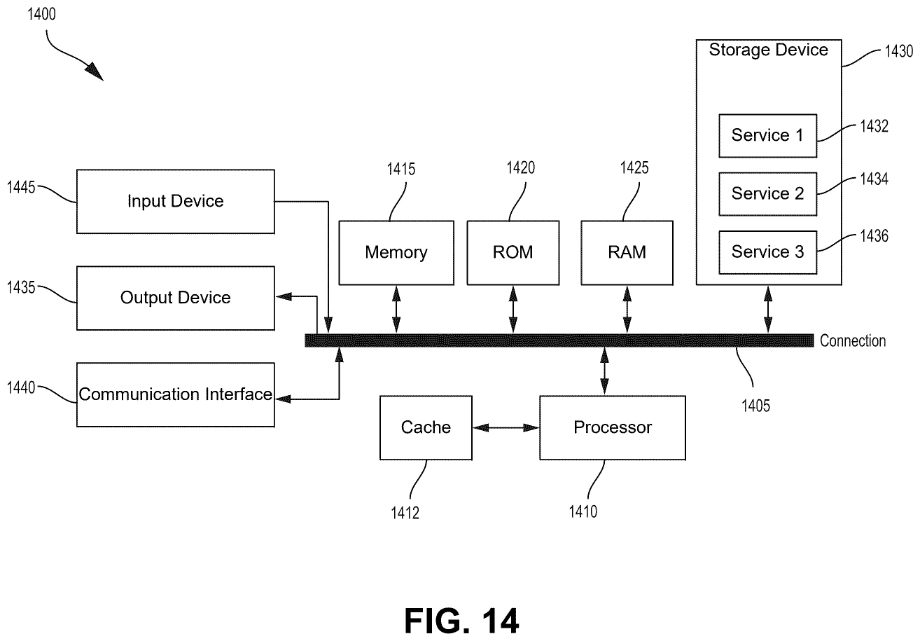

The image processor 150 may include one or more processors, such as one or more image signal processors (ISPs) (including ISP 154), one or more host processors (including host processor 152), and/or one or more of any other type of processor 1410 discussed with respect to the computing system 1400 of FIG. 14. The host processor 152 can be a digital signal processor (DSP) and/or other type of processor. In some implementations, the image processor 150 is a single integrated circuit or chip (e.g., referred to as a system-on-chip or SoC) that includes the host processor 152 and the ISP 154. In some cases, the chip can also include one or more input/output ports (e.g., input/output (I/O) ports 156), central processing units (CPUs), graphics processing units (GPUs), broadband modems (e.g., 3G, 4G or LTE, 5G, etc.), memory, connectivity components (e.g., Bluetooth™, Global Positioning System (GPS), etc.), any combination thereof, and/or other components. The I/O ports 156 can include any suitable input/output ports or interface according to one or more protocol or specification, such as an Inter-Integrated Circuit 2 (I2C) interface, an Inter-Integrated Circuit 3 (I3C) interface, a Serial Peripheral Interface (SPI) interface, a serial General Purpose Input/Output (GPIO) interface, a Mobile Industry Processor Interface (MIPI) (such as a MIPI CSI-2 physical (PHY) layer port or interface, an Advanced High-performance Bus (AHB) bus, any combination thereof, and/or other input/output port. In one illustrative example, the host processor 152 can communicate with the image sensor 130 using an I2C port, and the ISP 154 can communicate with the image sensor 130 using an MIPI port.

The image processor 150 may perform a number of tasks, such as de-mosaicing, color space conversion, image frame downsampling, pixel interpolation, automatic exposure (AE) control, automatic gain control (AGC), CDAF, PDAF, automatic white balance, merging of image frames to form an HDR image, image recognition, object recognition, feature recognition, receipt of inputs, managing outputs, managing memory, or some combination thereof. The image processor 150 may store image frames and/or processed images in random access memory (RAM) 140/1025, read-only memory (ROM) 145/1020, a cache, a memory unit, another storage device, or some combination thereof.

Various input/output (I/O) devices 160 may be connected to the image processor 150. The I/O devices 160 can include a display screen, a keyboard, a keypad, a touchscreen, a trackpad, a touch-sensitive surface, a printer, any other output devices, any other input devices, or some combination thereof. In some cases, a caption may be input into the image processing device 105B through a physical keyboard or keypad of the I/O devices 160, or through a virtual keyboard or keypad of a touchscreen of the I/O devices 160. The I/O devices 160 may include one or more ports, jacks, or other connectors that enable a wired connection between the image capture and processing system 100 and one or more peripheral devices, over which the image capture and processing system 100 may receive data from the one or more peripheral device and/or transmit data to the one or more peripheral devices. The I/O devices 160 may include one or more wireless transceivers that enable a wireless connection between the image capture and processing system 100 and one or more peripheral devices, over which the image capture and processing system 100 may receive data from the one or more peripheral device and/or transmit data to the one or more peripheral devices. The peripheral devices may include any of the previously-discussed types of I/O devices 160 and may themselves be considered I/O devices 160 once they are coupled to the ports, jacks, wireless transceivers, or other wired and/or wireless connectors.

In some cases, the image capture and processing system 100 may be a single device. In some cases, the image capture and processing system 100 may be two or more separate devices, including an image capture device 105A (e.g., a camera) and an image processing device 105B (e.g., a computing device coupled to the camera). In some implementations, the image capture device 105A and the image processing device 105B may be coupled together, for example via one or more wires, cables, or other electrical connectors, and/or wirelessly via one or more wireless transceivers. In some implementations, the image capture device 105A and the image processing device 105B may be disconnected from one another.

As shown in FIG. 1, a vertical dashed line divides the image capture and processing system 100 of FIG. 1 into two portions that represent the image capture device 105A and the image processing device 105B, respectively. The image capture device 105A includes the lens 115, control mechanisms 120, and the image sensor 130. The image processing device 105B includes the image processor 150 (including the ISP 154 and the host processor 152), the RAM 140, the ROM 145, and the I/O devices 160. In some cases, certain components illustrated in the image capture device 105A, such as the ISP 154 and/or the host processor 152, may be included in the image capture device 105A.

The image capture and processing system 100 can include an electronic device, such as a mobile or stationary telephone handset (e.g., smartphone, cellular telephone, or the like), a desktop computer, a laptop or notebook computer, a tablet computer, a set-top box, a television, a camera, a display device, a digital media player, a video gaming console, a video streaming device, an Internet Protocol (IP) camera, or any other suitable electronic device. In some examples, the image capture and processing system 100 can include one or more wireless transceivers for wireless communications, such as cellular network communications, 802.10 wi-fi communications, wireless local area network (WLAN) communications, or some combination thereof. In some implementations, the image capture device 105A and the image processing device 105B can be different devices. For instance, the image capture device 105A can include a camera device and the image processing device 105B can include a computing device, such as a mobile handset, a desktop computer, or other computing device.

While the image capture and processing system 100 is shown to include certain components, one of ordinary skill will appreciate that the image capture and processing system 100 can include more components than those shown in FIG. 1. The components of the image capture and processing system 100 can include software, hardware, or one or more combinations of software and hardware. For example, in some implementations, the components of the image capture and processing system 100 can include and/or can be implemented using electronic circuits or other electronic hardware, which can include one or more programmable electronic circuits (e.g., microprocessors, GPUs, DSPs, CPUs, and/or other suitable electronic circuits), and/or can include and/or be implemented using computer software, firmware, or any combination thereof, to perform the various operations described herein. The software and/or firmware can include one or more instructions stored on a computer-readable storage medium and executable by one or more processors of the electronic device implementing the image capture and processing system 100.

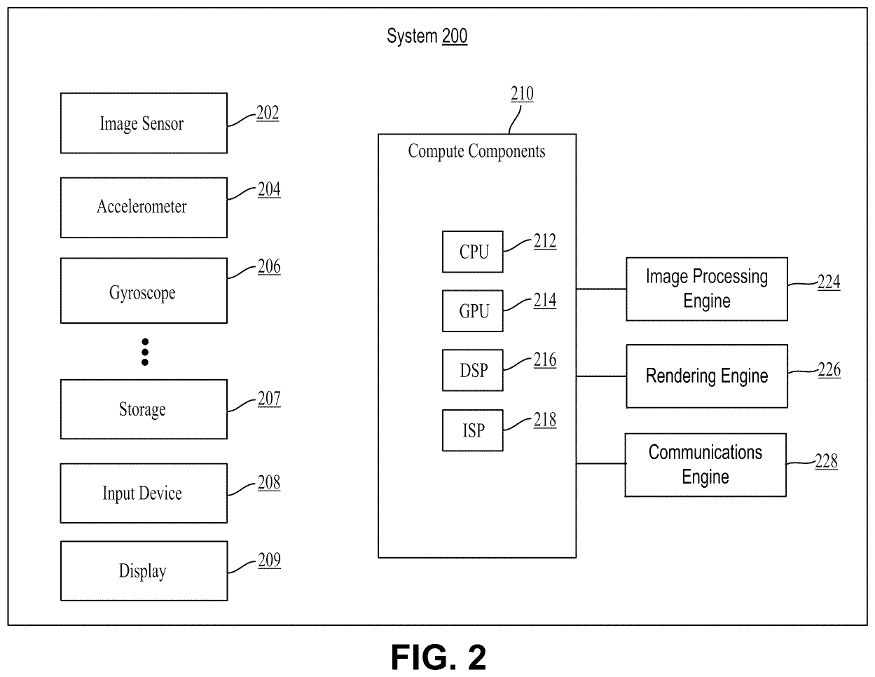

In some examples, the system 200 of FIG. 2 can include the image capture and processing system 100, the image capture device 105A, the image processing device 105B, or a combination thereof.

FIG. 2 is a diagram illustrating an architecture of an example system 200, in accordance with some aspects of the disclosure. The system 200 can run (or execute) applications and implement operations. In some examples, the system 200 can perform tracking and localization, and/or mapping of an environment in the physical world (e.g., a scene). For example, the system 200 can generate a map (e.g., a 3D map) of an environment in the physical world, and display the map on the display 209. The display 209 can include a glass, a screen, a lens, a projector, and/or other display mechanism.

In this illustrative example, the system 200 includes one or more image sensors 202 (e.g., cameras), an accelerometer 204, a gyroscope 206, storage 207, compute components 210, an engine 220, an image processing engine 224, a rendering engine 226, and a communications engine 228. It should be noted that the components 202-228 shown in FIG. 2 are non-limiting examples provided for illustrative and explanation purposes, and other examples can include more, fewer, or different components than those shown in FIG. 2. For example, in some cases, the system 200 can include one or more other sensors (e.g., one or more inertial measurement units (IMUs), RADARs, light detection and ranging (LIDAR) sensors, radio detection and ranging (RADAR) sensors, sound detection and ranging (SODAR) sensors, sound navigation and ranging (SONAR) sensors, audio sensors, etc.), one or more display devices, one more other processing engines, one or more other hardware components, and/or one or more other software and/or hardware components that are not shown in FIG. 2. While various components of the system 200, such as the image sensor 202, may be referenced in the singular form herein, it should be understood that the system 200 may include multiple of any component discussed herein (e.g., multiple image sensors 202).

The system 200 includes or is in communication with (wired or wirelessly) an input device 208. The input device 208 can include any suitable input device, such as a touchscreen, a pen or other pointer device, a keyboard, a mouse a button or key, a microphone for receiving voice commands, a gesture input device for receiving gesture commands, a video game controller, a steering wheel, a joystick, a set of buttons, a trackball, a remote control, any other input device 1045 discussed herein, or any combination thereof. In some cases, the image sensor 202 can capture images that can be processed for interpreting gesture commands.

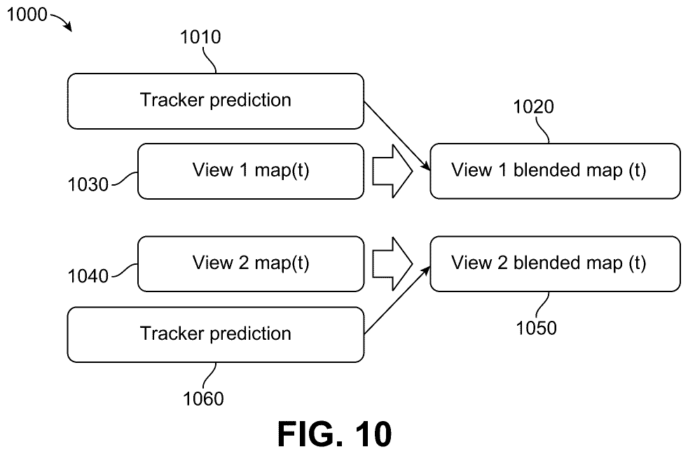

The system 200 can also communicate with one or more other electronic devices (wired or wirelessly). For example, communications engine 228 can be configured to manage connections and communicate with one or more electronic devices. In some cases, the communications engine 228 can correspond to the communications interface 1040 of FIG. 10.

In some implementations, the one or more image sensors 202, the accelerometer 204, the gyroscope 206, storage 207, compute components 210, engine 220, image processing engine 224, and rendering engine 226 can be part of the same computing device. For example, in some cases, the one or more image sensors 202, the accelerometer 204, the gyroscope 206, storage 207, compute components 210, engine 220, image processing engine 224, and rendering engine 226 can be integrated into a vehicle, an HMD, extended reality glasses, smartphone, laptop, tablet computer, gaming system, and/or any other computing device. However, in some implementations, the one or more image sensors 202, the accelerometer 204, the gyroscope 206, storage 207, compute components 210, engine 220, image processing engine 224, and rendering engine 226 can be part of two or more separate computing devices. For example, in some cases, some of the components 202-226 can be part of, or implemented by, one computing device and the remaining components can be part of, or implemented by, one or more other computing devices.

The storage 207 can be any storage device(s) for storing data. Moreover, the storage 207 can store data from any of the components of the system 200. For example, the storage 207 can store data from the image sensor 202 (e.g., image or video data), data from the accelerometer 204 (e.g., measurements), data from the gyroscope 206 (e.g., measurements), data from the compute components 210 (e.g., processing parameters, preferences, virtual content, rendering content, scene maps, tracking and localization data, object detection data, privacy data, application data, face recognition data, occlusion data, etc.), data from the engine 220, data from the image processing engine 224, and/or data from the rendering engine 226 (e.g., output frames). In some examples, the storage 207 can include a buffer for storing frames for processing by the compute components 210.

The one or more compute components 210 can include a central processing unit (CPU) 212, a graphics processing unit (GPU) 214, a digital signal processor (DSP) 216, an image signal processor (ISP) 218, and/or other processor (e.g., a neural processing unit (NPU) implementing one or more trained neural networks). The compute components 210 can perform various operations such as image enhancement, computer vision, graphics rendering, extended reality operations (e.g., tracking, localization, pose estimation, mapping, content anchoring, content rendering, etc.), image and/or video processing, sensor processing, recognition (e.g., text recognition, facial recognition, object recognition, feature recognition, tracking or pattern recognition, scene recognition, occlusion detection, etc.), trained machine learning operations, filtering, and/or any of the various operations described herein. In some examples, the compute components 210 can implement (e.g., control, operate, etc.) the engine 220, the image processing engine 224, and the rendering engine 226. In other examples, the compute components 210 can also implement one or more other processing engines.

The image sensor 202 can include any image and/or video sensors or capturing devices. In some examples, the image sensor 202 can be part of a multiple-camera assembly, such as a dual-camera assembly. The image sensor 202 can capture image and/or video content (e.g., raw image and/or video data), which can then be processed by the compute components 210, the engine 220, the image processing engine 224, and/or the rendering engine 226 as described herein. In some examples, the image sensors 202 may include an image capture and processing system 100, an image capture device 105A, an image processing device 105B, or a combination thereof.

In some examples, the image sensor 202 can capture image data and can generate images (also referred to as frames) based on the image data and/or can provide the image data or frames to the engine 220, the image processing engine 224, and/or the rendering engine 226 for processing. An image or frame can include a video frame of a video sequence or a still image. An image or frame can include a pixel array representing a scene. For example, an image can be a red-green-blue (RGB) image having red, green, and blue color components per pixel; a luma, chroma-red, chroma-blue (YCbCr) image having a luma component and two chroma (color) components (chroma-red and chroma-blue) per pixel; or any other suitable type of color or monochrome image.

In some cases, the image sensor 202 (and/or other camera of the system 200) can be configured to also capture depth information. For example, in some implementations, the image sensor 202 (and/or other camera) can include an RGB-depth (RGB-D) camera. In some cases, the system 200 can include one or more depth sensors (not shown) that are separate from the image sensor 202 (and/or other camera) and that can capture depth information. For instance, such a depth sensor can obtain depth information independently from the image sensor 202. In some examples, a depth sensor can be physically installed in the same general location as the image sensor 202, but may operate at a different frequency or frame rate from the image sensor 202. In some examples, a depth sensor can take the form of a light source that can project a structured or textured light pattern, which may include one or more narrow bands of light, onto one or more objects in a scene. Depth information can then be obtained by exploiting geometrical distortions of the projected pattern caused by the surface shape of the object. In one example, depth information may be obtained from stereo sensors such as a combination of an infra-red structured light projector and an infra-red camera registered to a camera (e.g., an RGB camera).

The system 200 can also include other sensors in its one or more sensors. The one or more sensors can include one or more accelerometers (e.g., accelerometer 204), one or more gyroscopes (e.g., gyroscope 206), and/or other sensors. The one or more sensors can provide velocity, orientation, and/or other position-related information to the compute components 210. For example, the accelerometer 204 can detect acceleration by the system 200 and can generate acceleration measurements based on the detected acceleration. In some cases, the accelerometer 204 can provide one or more translational vectors (e.g., up/down, left/right, forward/back) that can be used for determining a position or pose of the system 200. The gyroscope 206 can detect and measure the orientation and angular velocity of the system 200. For example, the gyroscope 206 can be used to measure the pitch, roll, and yaw of the system 200. In some cases, the gyroscope 206 can provide one or more rotational vectors (e.g., pitch, yaw, roll). In some examples, the image sensor 202 and/or the engine 220 can use measurements obtained by the accelerometer 204 (e.g., one or more translational vectors) and/or the gyroscope 206 (e.g., one or more rotational vectors) to calculate the pose of the system 200. As previously noted, in other examples, the system 200 can also include other sensors, such as an inertial measurement unit (IMU), a magnetometer, a gaze and/or eye tracking sensor, a machine vision sensor, a smart scene sensor, a speech recognition sensor, an impact sensor, a shock sensor, a position sensor, a tilt sensor, etc.

As noted above, in some cases, the one or more sensors can include at least one IMU. An IMU is an electronic device that measures the specific force, angular rate, and/or the orientation of the system 200, using a combination of one or more accelerometers, one or more gyroscopes, and/or one or more magnetometers. In some examples, the one or more sensors can output measured information associated with the capture of an image captured by the image sensor 202 (and/or other camera of the system 200) and/or depth information obtained using one or more depth sensors of the system 200.

The output of one or more sensors (e.g., the accelerometer 204, the gyroscope 206, one or more IMUs, and/or other sensors) can be used by the engine 220 to determine a pose of the system 200 and/or the pose of the image sensor 202 (or other camera of the system 200). In some cases, the pose of the system 200 and the pose of the image sensor 202 (or other camera) can be the same. The pose of image sensor 202 refers to the position and orientation of the image sensor 202 relative to a frame of reference (e.g., with respect to the scene 110). In some implementations, the camera pose can be determined for 6-Degrees Of Freedom (6DoF), which refers to three translational components (e.g., which can be given by X (horizontal), Y (vertical), and Z (depth) coordinates relative to a frame of reference, such as the image plane) and three angular components (e.g., roll, pitch, and yaw relative to the same frame of reference). In some implementations, the camera pose can be determined for 3-Degrees Of Freedom (3DoF), which refers to the three angular components (e.g., roll, pitch, and yaw).

In some cases, a device tracker (not shown) can use the measurements from the one or more sensors and image data from the image sensor 202 to track a pose (e.g., a 6DoF pose) of the system 200. For example, the device tracker can fuse visual data (e.g., using a visual tracking solution) from the image data with inertial data from the measurements to determine a position and motion of the system 200 relative to the physical world (e.g., the scene) and a map of the physical world. As described below, in some examples, when tracking the pose of the system 200, the device tracker can generate a three-dimensional (3D) map of the scene (e.g., the real world) and/or generate updates for a 3D map of the scene. The 3D map updates can include, for example and without limitation, new or updated features and/or feature or landmark points associated with the scene and/or the 3D map of the scene, localization updates identifying or updating a position of the system 200 within the scene and the 3D map of the scene, etc. The 3D map can provide a digital representation of a scene in the real/physical world. In some examples, the 3D map can anchor location-based objects and/or content to real-world coordinates and/or objects. The system 200 can use a mapped scene (e.g., a scene in the physical world represented by, and/or associated with, a 3D map) to merge virtual content or objects with the physical environment.

In some aspects, the pose of image sensor 202 and/or the system 200 as a whole can be determined and/or tracked by the compute components 210 using a visual tracking solution based on images captured by the image sensor 202 (and/or other camera of the system 200). For instance, in some examples, the compute components 210 can perform tracking using computer vision-based tracking, model-based tracking, and/or simultaneous localization and mapping (SLAM) techniques. For instance, the compute components 210 can perform SLAM or can be in communication (wired or wireless) with a SLAM system. SLAM refers to a class of techniques where a map of an environment (e.g., a map of an environment being modeled by system 200) is created while simultaneously tracking the pose of a camera (e.g., image sensor 202) and/or the system 200 relative to that map. The map can be referred to as a SLAM map, and can be three-dimensional (3D). The SLAM techniques can be performed using color or grayscale image data captured by the image sensor 202 (and/or other camera of the system 200), and can be used to generate estimates of 6DoF pose measurements of the image sensor 202 and/or the system 200. Such a SLAM technique configured to perform 6DoF tracking can be referred to as 6DoF SLAM. In some cases, the output of the one or more sensors (e.g., the accelerometer 204, the gyroscope 206, one or more IMUs, and/or other sensors) can be used to estimate, correct, and/or otherwise adjust the estimated pose.

In some cases, the 6DoF SLAM (e.g., 6DoF tracking) can associate features observed from certain input images from the image sensor 202 (and/or other camera) to the SLAM map. For example, 6DoF SLAM can use feature point associations from an input image to determine the pose (position and orientation) of the image sensor 202 and/or system 200 for the input image. 6DoF mapping can also be performed to update the SLAM map. In some cases, the SLAM map maintained using the 6DoF SLAM can contain 3D feature points triangulated from two or more images. For example, key frames can be selected from input images or a video stream to represent an observed scene. For every key frame, a respective 6DoF camera pose associated with the image can be determined. The pose of the image sensor 202 and/or the system 200 can be determined by projecting features from the 3D SLAM map into an image or video frame and updating the camera pose from verified 2D-3D correspondences.

In one illustrative example, the compute components 210 can extract feature points from certain input images (e.g., every input image, a subset of the input images, etc.) or from each key frame. A feature point (also referred to as a registration point) as used herein is a distinctive or identifiable part of an image, such as a part of a hand, an edge of a table, among others. Features extracted from a captured image can represent distinct feature points along three-dimensional space (e.g., coordinates on X, Y, and Z-axes), and every feature point can have an associated feature location. The feature points in key frames either match (are the same or correspond to) or fail to match the feature points of previously-captured input images or key frames. Feature detection can be used to detect the feature points. Feature detection can include an image processing operation used to examine one or more pixels of an image to determine whether a feature exists at a particular pixel. Feature detection can be used to process an entire captured image or certain portions of an image. For each image or key frame, once features have been detected, a local image patch around the feature can be extracted. Features may be extracted using any suitable technique, such as Scale Invariant Feature Transform (SIFT) (which localizes features and generates their descriptions), Learned Invariant Feature Transform (LIFT), Speed Up Robust Features (SURF), Gradient Location-Orientation histogram (GLOH), Oriented Fast and Rotated Brief (ORB), Binary Robust Invariant Scalable Keypoints (BRISK), Fast Retina Keypoint (FREAK), KAZE, Accelerated KAZE (AKAZE), Normalized Cross Correlation (NCC), descriptor matching, another suitable technique, or a combination thereof.

In some cases, sensor data, such as images captured by the image capture and processing system 100 of FIG. 1, point clouds captured by LIDAR/RADAR sensors, etc., may be processed by neural networks and/or machine learning (ML) systems. A neural network is an example of an ML system, and a neural network can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low level characteristics of an input, and later layers building up a hierarchy of more complex and abstract characteristics.

As previously mentioned, object detection algorithms typically suffer from missed detections of targets (e.g., objects) when the targets are heavily occluded. These missed detections occur because the object detectors generally depend upon local features of a target within an image, and these local features may be strongly affected when the target is occluded.

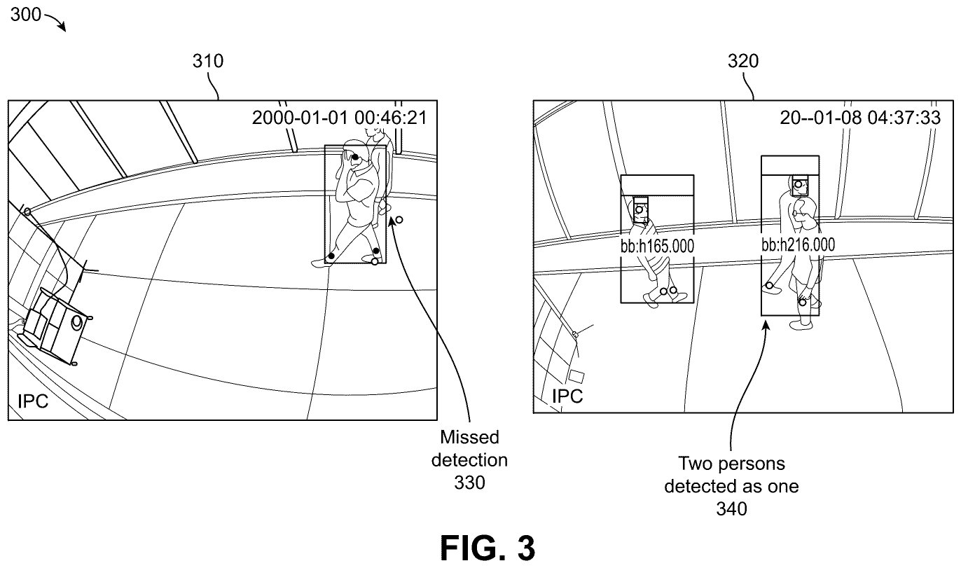

FIG. 3 shows an example of missed detections of targets (e.g., objects). In particular, FIG. 3 is a diagram illustrating examples 300 of images 310, 320 with missed detections of targets that are occluded. In FIG. 3, image 310 shows an example of a missed detection 330 of a first person that is occluded by a second person being located in front of the first person within this particular camera view of the scene. For this missed detection, the object detection system only detects the second person in front of the occluded first person.

Image 320 in FIG. 3 shows another missed detection of a first person that is occluded by a second person. For this missed detection, the object detection system is detecting the two people as only a single person 340 and, as such, there is a missed detection of the occluded first person.

There are existing object detection solutions that are currently utilized that can result in a lower number of missed detections. One such solution involves lowering the probability detection threshold (e.g., which may be used to determine whether an object has indeed been detected), which may allow for more detections. This solution, however, can lead to an increase in false positive detections (e.g., detections of objects that are not actually present in the scene). Another solution involves collecting and annotating additional data in a similar setting (e.g., in a partial view of the object due to the occlusion). This solution, however, may result in an increase in cost for the additional data collection and annotations. An additional solution involves deploying a larger object detection model to obtain more detections. However, a larger object detection model may have a reduced model efficiency as compared to smaller object detection models. Therefore, improved systems and techniques for object detection that can result in a lower number of missed detections can be useful.

In a multi-camera system, an object occluded in one view is not always occluded in another view, which may yield strong a detection (e.g., a detection with a high probability of an object being actually occurring within the scene). A detection of an object (e.g., with a high probability of the object occurring) in one view of a scene may be employed as prior for another view (e.g., which may have an occluded view of the object).

In one or more aspects, the systems and techniques provide object detection and tracking with a location prior. In one or more examples, the systems and techniques employ a location prior, which may be derived from a view (e.g., a first view) of a scene with a strong detection of one or more objects (e.g., a detection with a high probability), for another view (e.g., a second view) of the scene, which can have a weak detection of the one or more objects (e.g., a detection with a low probability) that can be caused by the one or more objects being occluded within this view (e.g., the second view). The usage of a location prior from other camera views (or from a joint tracker) can effectively reduce missed object detections that result from occlusion and, thus, can improve object detection performance and accuracy.

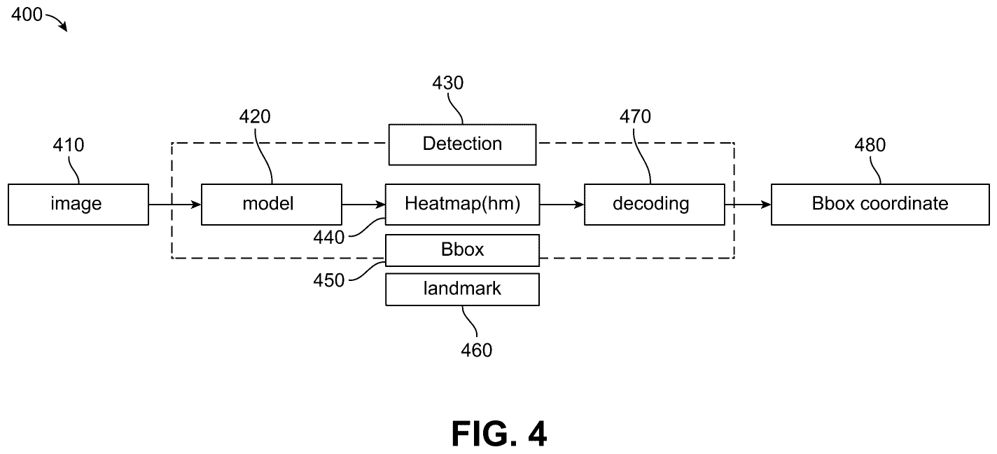

FIG. 4 shows an example of an object detection process. In particular, FIG. 4 is a diagram illustrating an example of an object detection pipeline 400 of an object detection process. In FIG. 4, during operation of the object detection pipeline 400, an image 410 can be obtained by a camera of a device with a view of a scene including one or more objects. The image 410 can be inputted into a detection module 430 of the device.

In the detection module 430, a model 420 can process the image 410 to generate and output a probability map 440. In some examples, the probability map may be in the form of a heat map (hm), such as a jet color map. In one or more examples, the probability map 440 can include probabilities of one or more objects being located at locations within the scene. In some examples, the model 420 can also generate and output one or more bounding boxes (bboxes) 450 (e.g., a human bounding box) for each object (e.g., person) detected within the scene and/or one or more landmarks 460 associated with the one or more detected objects within the scene.

A decoder can then decode 470 (e.g., by performing post processing, such as performing non-maximum suppression (NMS) to obtain the highest probability scores of the probability map 440) the output of the model 420 (e.g., which includes the probability map 440, the bounding boxes 450, and/or the landmarks 460) to generate bounding box coordinates 480 for bounding boxes for each of the detected objects within the scene.

The systems and techniques improve object detection performance (e.g., by reducing the number of missed detections) by enhancing the probability map 440 to increase the accuracy of the probability map 440. In one or more examples, a prior from a view of the scene with a strong detection of the one or more objects can be used to enhance the probability map 440.

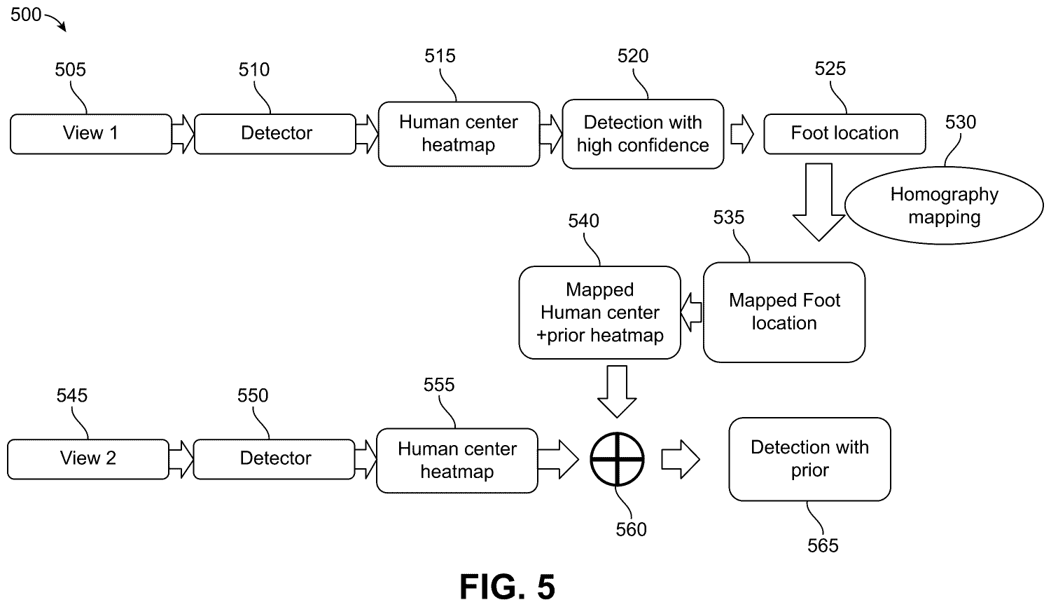

FIG. 5 shows an example process for object detection that utilizes an enhanced probability map (e.g., heat map) for objects within a scene. In particular, FIG. 5 is a diagram illustrating an example of a process 500 for object detection and tracking with a location prior. In FIG. 5, during the process 500 for object detection, a camera (e.g., of a first device), with a first view (e.g., view 1 505) of a scene including one or more objects, may obtain a first image of the scene. One or more processors (e.g., and/or a detector 510 of the first device) may determine, based on the first image, a first probability map (e.g., a heat map, such as a human center heat map 515) including first probabilities of the one or more objects being located at locations within the scene. The first probability map can have detection of the one or more objects with a high confidence 520 (e.g., high probabilities of the one or more objects being present within the scene).

The one or more processors may determine, based on the first image, a location of an item (e.g., a foot location 525) associated with each object of the one or more objects. In one or more examples, the item associated with each object of the one or more objects may be a foot (e.g., where each object of the one or more objects is a human). The one or more processors may map the item (e.g., mapped foot location 535) associated with each object of the one or more objects from the first view to a second view to produce a prior probability map (e.g., a mapped human center plus prior heat map 540) associated with the second view. In one or more examples, mapping the item (e.g., foot) associated with each object of the one or more objects from the first view to the second view may be based on homography mapping 530.

The camera or another camera (e.g., of the first device or a second device), with a second view (e.g., view 2 545) of the scene, may obtain a second image of the scene. One or more processors (e.g., and/or a detector 550 of the first device or the second device) may determine, based on the second image, a second probability map (e.g., a heat map, such as a human center heat map 555) including second probabilities of the one or more objects being located at the locations within the scene. The one or more processors (e.g., of the first device or the second device) may blend 560 the second probability map (e.g., human center heat map 555) with the prior probability map (e.g., a mapped human center plus prior heat map 540) to produce a blended probability map. The one or more processors (e.g., of the first device or the second device) may detect, based on the blended probability map (e.g., may perform a detection with prior 565), the one or more objects of the scene.

In some examples, the one more processors (e.g., of the first device or the second device) may determine, based on the second image, a location of the item (e.g., foot) associated with each object of the one or more objects. The one or more processors may map the item associated with each object of the one or more objects from the second view to a first view to produce another prior probability map associated with the first view. The one or more processors may blend the first probability map (e.g., human center heatmap 515) with the other prior probability map to produce another blended probability map. The one or more processors may detect, based on the other blended probability map, the one or more objects of the scene.

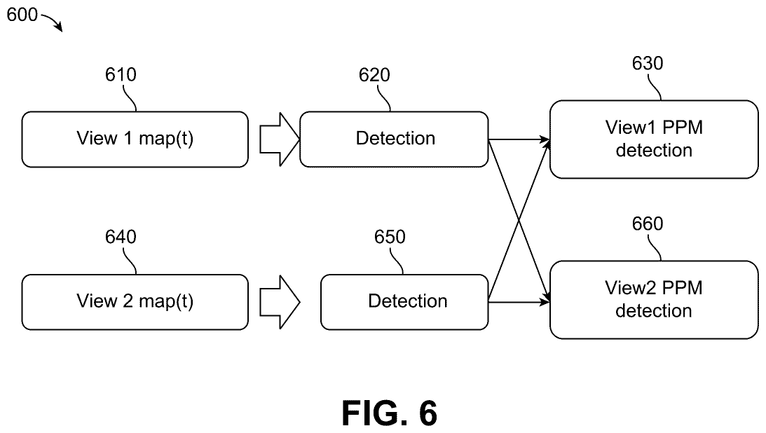

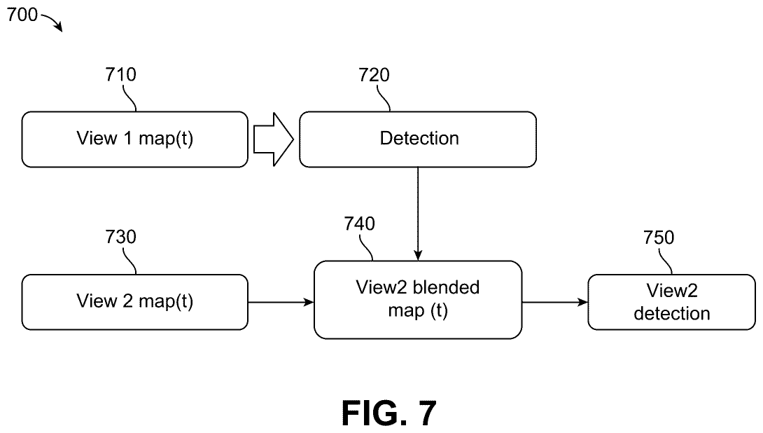

FIGS. 6 and 7 show examples of prior application methods. In particular, FIG. 6 is a diagram illustrating an example of a prior application process 600 for object detection and tracking, where the process 600 applies prior probability maps to two views. FIG. 6 shows a first probability map 610 (e.g., view 1 map (t)) that corresponds to a first image obtained (e.g., captured) at a time t by a camera with a first view (e.g., view 1) of a scene including one or more objects. The first probability map 610 can have detection 620 of the one or more objects within the scene with a certain confidence.

Based on the first image, a location of an item (e.g., a foot) associated with each object of the one or more objects can be determined. During view 1 position prior mapping (PPM) detection 630, the item (e.g., foot) associated with each object of the one or more objects may be mapped from a second view (e.g., view 2) to the first view (e.g., view 1) to produce a second prior probability map associated with the first view.

FIG. 6 also shows a second probability map 640 (e.g., view 2 map (t)) that corresponds to a second image obtained (e.g., captured) at the time t by the camera (or another camera) with a second view (e.g., view 2) of the scene including the one or more objects. The second probability map 640 can have detection 650 of the one or more objects within the scene with a confidence.

Based on the second image, a location of an item (e.g., a foot) associated with each object of the one or more objects can be determined. During view 2 PPM detection 660, the item (e.g., foot) associated with each object of the one or more objects may be mapped from the first view (e.g., view 1) to the second view (e.g., view 2) to produce a first prior probability map associated with the second view.

During view 1 PPM detection 630, the second probability map may be blended (e.g., using PPM) with the first prior probability map to produce a first blended probability map. Also during view 1 PPM detection 630, the one or more objects of the scene can be detected based on the first blended probability map.

During view 2 PPM detection 660, the first probability map may be blended (e.g., using PPM) with the second prior probability map to produce a second blended probability map. Also during view 2 PPM detection 660, the one or more objects of the scene can be detected based on the second blended probability map.

In one or more examples, the prior application process 600 of FIG. 6 can have the advantage of benefiting by using priors from both of the views (e.g., view 1 and view 2). However, the prior application process 600 may have an additional computation cost due to the two-stage decoding of the method.

FIG. 7 is a diagram illustrating an example of a prior application process 700 for object detection and tracking, where the method applies a position prior (e.g., a prior probability map) to a single view. In some cases, it may be more effective to utilize a prior probability map from only one view (e.g., when the one view (view 1) has a stronger detection of objects within the scene than another view (view 2)).

FIG. 7 shows a first probability map 710 (e.g., view 1 map (t)) that corresponds to a first image obtained (e.g., captured) at a time t by a camera with a first view (e.g., view 1) of a scene including one or more objects. The first probability map 710 can have detection 720 of the one or more objects within the scene with a certain confidence.

Based on the first image, a location of an item (e.g., a foot) associated with each object of the one or more objects can be determined. The item (e.g., foot) associated with each object of the one or more objects may be mapped from the first view (e.g., view 1) to a second view (e.g., view 2) to produce a prior probability map associated with the second view.

FIG. 7 additionally shows a second probability map 730 (e.g., view 2 map (t)) that corresponds to a second image obtained (e.g., captured) at the time t by the camera (or another camera) with a second view (e.g., view 2) of the scene including the one or more objects. The second probability map 730 can have detection of the one or more objects within the scene with a confidence.

The second probability map may be blended (e.g., using PPM) with the prior probability map to produce a blended probability map (e.g., view 2 blended map (t) 740). The one or more objects of the scene can be detected (e.g., view 2 detection 750) based on the blended probability map.

In one or more examples, the prior application process 700 of FIG. 7 can have the advantage of not having any additional computation costs because only a single-stage decoding is used. However, only one view can benefit from the prior application process 700 of FIG. 7.

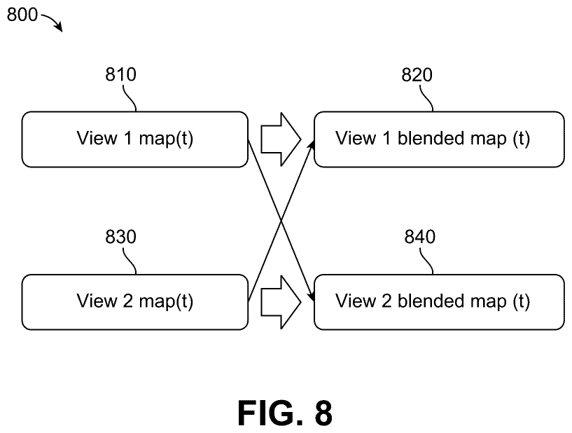

FIGS. 8, 9, and 10 show examples of position prior generation methods. In particular, FIG. 8 is a diagram illustrating an example of a position prior generation process 800 for object detection and tracking, where the process 800 generates a prior map from a current frame. In FIG. 8 a first image and a second image may be obtained at a same time. The process 800 can produce accurate detection results. However, the process 800 may be time consuming due to post-processing twice of each of the two probability maps, and can require synchronization.

FIG. 8 shows a first probability map 810 (e.g., view 1 map (t)) that corresponds to a first image obtained (e.g., captured) at a time t by a camera with a first view (e.g., view 1) of a scene including one or more objects. The first probability map 810 can have detection of the one or more objects within the scene with a certain confidence.

Based on the first image, a location of an item (e.g., a foot) associated with each object of the one or more objects can be determined. The item (e.g., foot) associated with each object of the one or more objects may be mapped from the first view (e.g., view 1) to a second view (e.g., view 2) to produce a first prior probability map associated with the second view.

FIG. 8 also shows a second probability map 830 (e.g., view 2 map (t)) that corresponds to a second image obtained (e.g., captured) at the time t by the camera (or another camera) with a second view (e.g., view 2) of the scene including the one or more objects. The second probability map 830 can have detection of the one or more objects within the scene with a confidence.

Based on the second image, a location of an item (e.g., a foot) associated with each object of the one or more objects can be determined. The item (e.g., foot) associated with each object of the one or more objects may be mapped from the second view (e.g., view 2) to the first view (e.g., view 1) to produce a second prior probability map associated with the first view.

The second probability map may be blended (e.g., using PPM) with the first prior probability map to produce a first blended probability map (e.g., view 2 blended map (t) 840). The first probability map may be blended (e.g., using PPM) with the second prior probability map to produce a second blended probability map (e.g., view 1 blended map (t) 820).

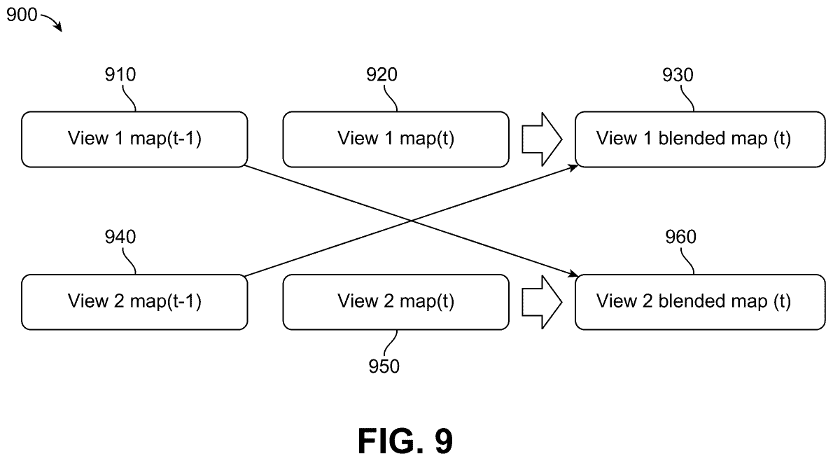

FIG. 9 is a diagram illustrating an example of a position prior generation process 900 for object detection and tracking, where the process 900 generates a prior map from a previous frame. In FIG. 9, a first image may be obtained at a first time, a second image may be obtained at a second time, and the first time may be prior to the second time. The process 900 only requires post-processing once for each of the two probability maps. However, with this process 900, a fast moving object may move between the captured image frames, which may lead to inaccurate detection results.

FIG. 9 shows a first probability map 910 (e.g., view 1 map (t−1)) that corresponds to a first image obtained (e.g., captured) at a time t−1 by a camera with a first view (e.g., view 1) of a scene including one or more objects. The first probability map 910 can have detection of the one or more objects within the scene with a certain confidence. FIG. 9 also shows a third probability map 920 (e.g., view 1 map (t)) that corresponds to a third image obtained (e.g., captured) at a time t by a camera with the first view (e.g., view 1) of a scene including the one or more objects.

Based on the first image, a location of an item (e.g., a foot) associated with each object of the one or more objects can be determined. The item (e.g., foot) associated with each object of the one or more objects may be mapped from the first view (e.g., view 1) to a second view (e.g., view 2) to produce a first prior probability map associated with the second view.

FIG. 9 also shows a second probability map 940 (e.g., view 2 map (t−1)) that corresponds to a second image obtained (e.g., captured) at the time t−1 by the camera (or another camera) with a second view (e.g., view 2) of the scene including the one or more objects. The second probability map 940 can have detection of the one or more objects within the scene with a confidence. FIG. 9 also shows a fourth probability map 950 (e.g., view 2 map (t)) that corresponds to a fourth image obtained (e.g., captured) at a time t by a camera with the second view (e.g., view 2) of a scene including the one or more objects.

Based on the second image, a location of an item (e.g., a foot) associated with each object of the one or more objects can be determined. The item (e.g., foot) associated with each object of the one or more objects may be mapped from the second view (e.g., view 2) to the first view (e.g., view 1) to produce a second prior probability map associated with the first view.

The fourth probability map 950 (e.g., view 2 map (t)) may be blended (e.g., using PPM) with the first prior probability map to produce a first blended probability map 960 (e.g., view 2 blended map (t)). The third probability map 920 (e.g., view 1 map (t)) may be blended (e.g., using PPM) with the second prior probability map to produce a second blended probability map 930 (e.g., view 1 blended map (t)).

FIG. 10 is a diagram illustrating an example of a position prior generation process 1000 for object detection and tracking, where the process 1000 generates a prior map from a multi-camera tracker predicted location. The process 1000 can produce accurate detection results due to the tracker predictions. However, for this process 1000, the tracker can need to be maintained and the tracker may already be in use for a multi-camera tracking.

In FIG. 10, a tracker (e.g., of a device), with a first view (e.g., view 1) of a scene including one or more objects, may obtain a first probability map 1010 (e.g., a first tracker prediction) including first probabilities of the one or more objects being located at locations within the scene at a current time t based on the tracking result at t−1. The first probability map 1010 can have detection of the one or more objects within the scene with a certain confidence.

FIG. 10 also shows a third probability map 1030 (e.g., view 1 map (t)) that corresponds to a third image obtained (e.g., captured) at a time t by a camera with the first view (e.g., view 1) of a scene including the one or more objects.

In FIG. 10, the tracker or another tracker (e.g., of the device or another device), with a second view (e.g., view 2) of the scene including the one or more objects, may obtain a second probability map 1060 (e.g., a second tracker prediction) including second probabilities of the one or more objects being located at locations within the scene at a current time t based on the tracking result at t−1. The second probability map 1060 can have detection of the one or more objects within the scene with a confidence.

FIG. 10 also shows a fourth probability map 1040 (e.g., view 2 map (t)) that corresponds to a fourth image obtained (e.g., captured) at a time t by a camera with the second view (e.g., view 2) of a scene including the one or more objects.

The third probability map 1030 may be blended (e.g., using PPM) with the first probability map 1010 to produce a first blended probability map 1020 (e.g., view 1 blended map (t)). The fourth probability map 1040 may be blended (e.g., using PPM) with the second probability map 1060 to produce a second blended probability map 1050 (e.g., view 2 blended map (t)).

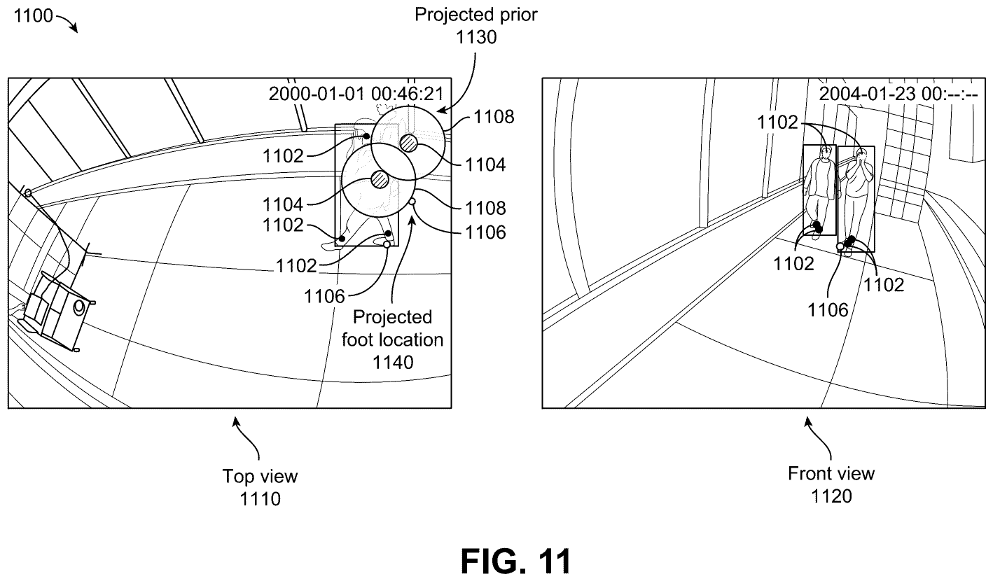

In one or more aspects, an example of a process for object detection and tracking may include the following steps. In one or more examples, homography mapping may be performed for two views (e.g., view A and view B) of a scene including one or more objects. In some examples, a detector can estimate a bounding box (e.g., a human bounding box, such as the bounding boxes shown in image 1110 of FIG. 11), and foot location (e.g., solid dots 1102 in image 1110 of FIG. 11) in both views of the scene. In one or more examples, a first round detection result can be generated in both views with a strong detection. In some examples, an item (e.g., foot) location can be mapped from view A to view B (e.g., as shown by the hollowed dots 1106 in FIG. 11), and the corresponding center location can be estimated in view B (e.g., as shown by the patterned dots 1104 in FIG. 11). In some examples, a prior probability map (e.g., as shown by the circles 1108 in FIG. 11) (e.g., a cross-view prior map) can be generated using a Gaussian kernel. In one or more examples, a blended probability map (e.g., hm′) can be generated based on a prior probability map (e.g., hm_prior) and an original probability map (e.g., hm). In some examples, decoding can be performed on the blended probability map (e.g., hm′) for detection of the one or more objects within the scene.

In one or more aspects, different prior blending methods may be employed for the systems and techniques to produce a blended probability map (e.g., hm′). In one or more examples, blending a probability map (e.g., hm) with a prior probability map (e.g., hm_prior) may be based on a weighted sum of the probability map and the prior probability map (e.g., hm′=hm_ws=alpha*hm+beta*hm_prior), a product of the probability map and the prior probability map (e.g., hm′=hm*hm_prior), a confidence preserve of the probability map, or a prior boosting of the prior probability map.

In some examples, when the blending is based on the confidence preserve of the probability map and the probability map has a confidence level greater than or equal to a confidence threshold, the blended probability map may include only the probability map (e.g., hm′=hm). In one or more examples, when the blending is based on the confidence preserve of the prior probability map and the probability map has a confidence level less than the confidence threshold, the blended probability map may be based on a weighted sum of the probability map and the prior probability map (e.g., hm′=hm_ws). In some examples, when the blending is based on the prior boosting of the prior probability map, the blended probability map may include a sum of the probability map and a weighted prior probability map (e.g., hm′=hm+beta*hm_prior).

FIG. 11 shows an example of an image with a strong detection being used as a prior. In particular, FIG. 11 is a diagram illustrating examples 1100 of images 1110, 1120 of a scene, where an image 1120 with a non-occluded view of targets is used as a prior. In FIG. 11, the image 1120 is shown to have a front view of a scene including two people. The image 1120 is shown to have a clear view of the two people and, as such, is able to detect both of the people (e.g., as shown by the two bounding boxes within the image 1120).

Image 1110 is shown to have a top view of the scene, where one person is shown to be occluded by the other person. Since image 1120 has a clear view of the scene with a strong detection of both of the people, image 1120 can be used as a prior for image 1110, which has an occluded view of one of the people. The projected prior 1130 from image 1120 (e.g., when being used as a prior) for the occluded person in image 1110 is shown in image 1110. The projected foot location 1140 (e.g., based on the image 1120 being used as a prior) of the foot of the occluded person is also shown in image 1110.

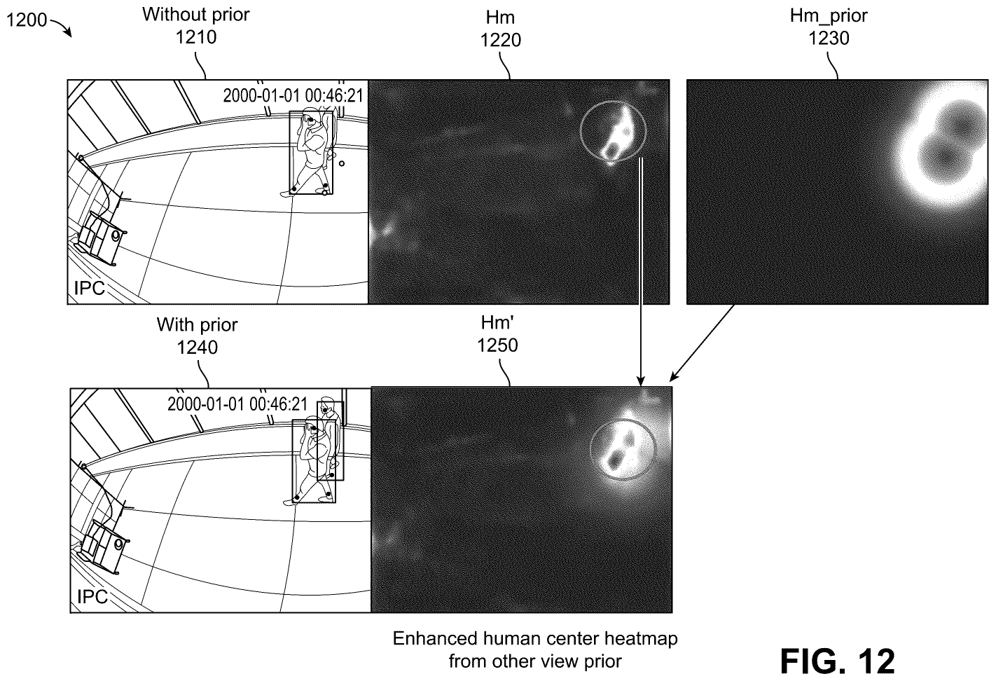

FIG. 12 is a diagram illustrating examples 1200 of images 1210, 1240 and probability maps 1220, 1230, 1250 showing a process for object detecting using a prior application method. In FIG. 12, a probability map 1220 (e.g., hm) corresponding to an image 1210 (or image 1240) of a scene including two people obtained from a first view of a camera is shown. The probability map 1220 is generated without using a prior from another view of the scene. In the image 1210, one of the two people is shown to be occluded by the other person. As such, the probability map 1220 shows a weak detection (e.g., a low probability) for the occluded person in image 1210.

In FIG. 12, a prior probability map 1230 (e.g., hm_prior) obtained from a second view of the scene is shown. The prior probability map 1230 is generated using another image obtained from the second view of the scene. The prior probability map 1230 shows a strong detection (e.g., a high probability) for both of the people (e.g., including the occluded person in image 1210) in the scene.

In FIG. 12, a blended probability map 1250 (e.g., hm′) generated by blending the probability map 1220 (e.g., hm) with the prior probability map 1230 (e.g., hm_prior) is shown. The blended probability map 1250 (e.g., hm′) shows strong detections for both of the people in image 1210 and, as such, the blended probability map 1250 (e.g., hm′) provides an enhanced probability map (e.g., heatmap) by using a prior from another view.

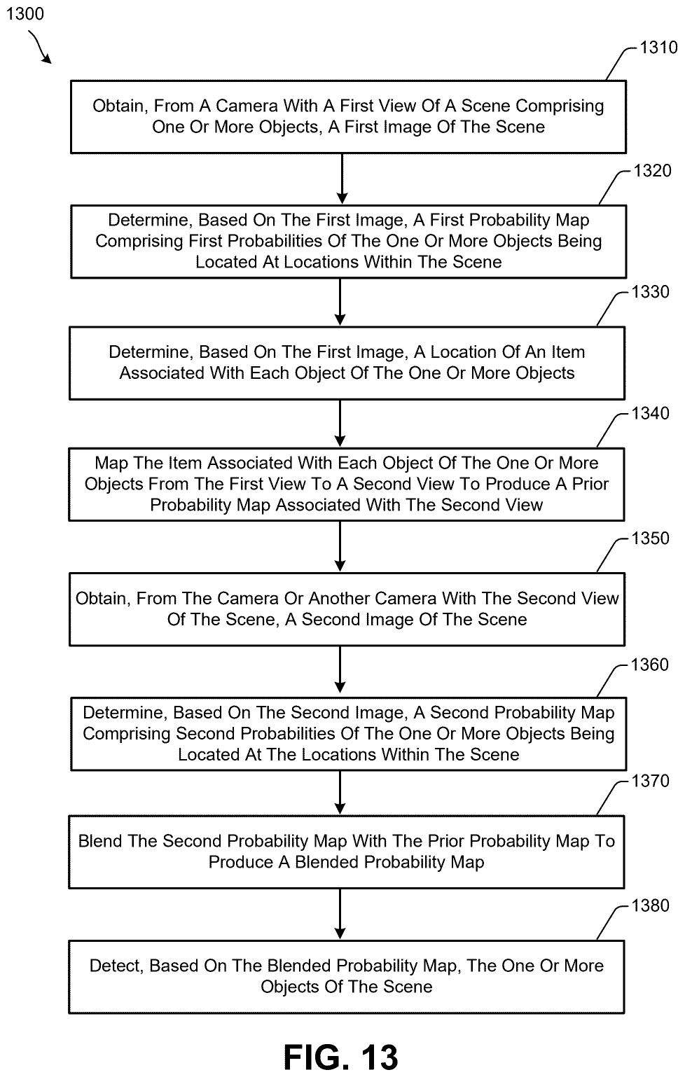

FIG. 13 is a flow chart illustrating an example of a process 1300 for object detection. The process 1300 can be performed by a computing device (e.g., the image capture and processing system 100 of FIG. 1, the system 200 of FIG. 2, a device including the object detection pipeline 400 of FIG. 4, a device configured to implement the process 500 of FIG. 5, the process 600 of FIG. 6, the process 700 of FIG. 7, the process 800 of FIG. 8, the process 900 of FIG. 9, and/or the process 1000 of FIG. 10, a computing device or computing system 1400 of FIG. 14, and/or other computing device or system) or by a component or system (e.g., a chipset, one or more processors such as one or more central processing units (CPUs), digital signal processors (DSPs), graphics processing units (GPUs), any combination thereof, and/or other type of processor(s), or other component or system) of the computing device. The operations of the process 1300 may be implemented as software components that are executed and run on one or more processors (e.g., processor 1410 of FIG. 14 or other processor(s)). Further, the transmission and reception of signals by the computing device in the process 1300 may be enabled, for example, by one or more antennas and/or one or more transceivers (e.g., wireless transceiver(s)).

At block 1310, the computing device (or component thereof) can obtain, from a camera with a first view (e.g., view 1 505 of FIG. 5, etc.) of a scene including one or more objects, a first image of the scene.

At block 1320, the computing device (or component thereof) can determine, based on the first image, a first probability map (e.g., heatmap 515 of FIG. 5) including first probabilities of the one or more objects being located at locations within the scene.

At block 1330, the computing device (or component thereof) can determine, based on the first image, a location (e.g., location 525 of FIG. 5) of an item associated with each object of the one or more objects. In one illustrative example, the item associated with each object of the one or more objects is a foot. Other examples of the item can include a hand, a leg, a portion of a building, a portion of a vehicle, or other item.

At block 1340, the computing device (or component thereof) can map the item associated with each object of the one or more objects from the first view to a second view to produce a prior probability map associated with the second view (e.g., mapped foot location 535 of FIG. 5). In some aspects, the computing device (or component thereof) can map the item associated with each object of the one or more objects from the first view to the second view based on homography mapping.

At block 1350, the computing device (or component thereof) can obtain, from the camera or another camera with the second view (e.g., the view 2 545) of the scene, a second image of the scene. In some aspects, the computing device (or component thereof) can obtain the first image and the second image at a same time. In some aspects, the computing device (or component thereof) can obtain the first image at a first time and obtain the second image at a second time, wherein the first time is prior to the second time.

At block 1360, the computing device (or component thereof) can determine, based on the second image, a second probability map (e.g., heatmap 555 of FIG. 5) including second probabilities of the one or more objects being located at the locations within the scene. In some cases, the first probability map and the second probability map are each a heatmap (e.g., the first probability map is a first heatmap and the second probability map is a second heatmap), such as the heatmap 515 and heatmap 555 of FIG. 5, respectively.

At block 1370, the computing device (or component thereof) can blend (e.g., blend 560 of FIG. 5) the second probability map with the prior probability map to produce a blended probability map. In some aspects, the computing device (or component thereof) can blend the second probability map with the prior probability map based on a weighted sum of the second probability map and the prior probability map, a product of the second probability map and the prior probability map, a confidence preserve of the second probability map, or a prior boosting of the prior probability map. For example, the blended probability map can include the second probability map based on the blending being based on the confidence preserve of the second probability map and the second probability map having a confidence level greater than or equal to a confidence threshold. In another example, the blended probability map can include a weighted sum of the prior probability map and the second probability map based on the blending being based on the confidence preserve of the prior probability map and the second probability map having a confidence level less than a confidence threshold. In another example, the blended probability map can include a sum of the second probability map and a weighted prior probability map based on the blending being based on the prior boosting of the prior probability map.

At block 1380, the computing device (or component thereof) can detect, based on the blended probability map, the one or more objects of the scene (e.g., the detection with prior 565 of FIG. 5). In some aspects, the computing device (or component thereof) can determine, based on the second image, a location of the item associated with each object of the one or more objects. The computing device (or component thereof) can map the item associated with each object of the one or more objects from the second view to a first view to produce an additional prior probability map associated with the first view. The computing device (or component thereof) can blend the first probability map with the additional prior probability map to produce an additional blended probability map and can detect, based on the additional blended probability map, the one or more objects of the scene.

In some cases, the computing device of process 1300 may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the Wi-Fi (802.11x) standards, data according to the Bluetooth™ standard, data according to the Internet Protocol (IP) standard, and/or other types of data.

The components of the computing device of process 1300 can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein. The computing device may further include a display (as an example of the output device or in addition to the output device), a network interface configured to communicate and/or receive the data, any combination thereof, and/or other component(s). The network interface may be configured to communicate and/or receive Internet Protocol (IP) based data or other type of data.

The process 1300 is illustrated as a logical flow diagram, the operations of which represent a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, process 1300 may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program including a plurality of instructions executable by one or more processors. The computer-readable or machine-readable storage medium may be non-transitory.

FIG. 14 is a block diagram illustrating an example of a computing system 1400, which may be employed for object detection and tracking with a location prior. In particular, FIG. 14 illustrates an example of computing system 1400, which can be for example any computing device making up internal computing system, a remote computing system, a camera, or any component thereof in which the components of the system are in communication with each other using connection 1405. Connection 1405 can be a physical connection using a bus, or a direct connection into processor 1410, such as in a chipset architecture. Connection 1405 can also be a virtual connection, networked connection, or logical connection.

In some aspects, computing system 1400 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

Example system 1400 includes at least one processing unit (CPU or processor) 1410 and connection 1405 that communicatively couples various system components including system memory 1415, such as read-only memory (ROM) 1420 and random access memory (RAM) 1425 to processor 1410. Computing system 1400 can include a cache 1412 of high-speed memory connected directly with, in close proximity to, or integrated as part of processor 1410.

Processor 1410 can include any general purpose processor and a hardware service or software service, such as services 1432, 1434, and 1436 stored in storage device 1430, configured to control processor 1410 as well as a special-purpose processor where software instructions are incorporated into the actual processor design. Processor 1410 may essentially be a completely self-contained computing system, containing multiple cores or processors, a bus, memory controller, cache, etc. A multi-core processor may be symmetric or asymmetric.

To enable user interaction, computing system 1400 includes an input device 1445, which can represent any number of input mechanisms, such as a microphone for speech, a touch-sensitive screen for gesture or graphical input, keyboard, mouse, motion input, speech, etc. Computing system 1400 can also include output device 1435, which can be one or more of a number of output mechanisms. In some instances, multimodal systems can enable a user to provide multiple types of input/output to communicate with computing system 1400.

Computing system 1400 can include communications interface 1440, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1440 may also include one or more range sensors (e.g., LiDAR sensors, laser range finders, RF radars, ultrasonic sensors, and infrared (IR) sensors) configured to collect data and provide measurements to processor 1410, whereby processor 1410 can be configured to perform determinations and calculations needed to obtain various measurements for the one or more range sensors. In some examples, the measurements can include time of flight, wavelengths, azimuth angle, elevation angle, range, linear velocity and/or angular velocity, or any combination thereof. The communications interface 1440 may also include one or more Global Navigation Satellite System (GNSS) receivers or transceivers that are used to determine a location of the computing system 1400 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1430 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1430 can include software services, servers, services, etc., that when the code that defines such software is executed by the processor 1410, it causes the system to perform a function. In some aspects, a hardware service that performs a particular function can include the software component stored in a computer-readable medium in connection with the necessary hardware components, such as processor 1410, connection 1405, output device 1435, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects can be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories can include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, engines, circuits, and algorithm steps described in connection with the embodiments disclosed herein may be implemented as electronic hardware, computer software, firmware, or combinations thereof. To clearly illustrate this interchangeability of hardware and software, various illustrative components, blocks, engines, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as engines, modules, or components may be implemented together in an integrated logic device or separately as discrete but interoperable logic devices. If implemented in software, the techniques may be realized at least in part by a computer-readable data storage medium including program code including instructions that, when executed, performs one or more of the methods described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein. In addition, in some aspects, the functionality described herein may be provided within dedicated software modules or hardware modules configured for encoding and decoding, or incorporated in a combined video encoder-decoder (CODEC).

Illustrative aspects of the disclosure include:

Aspect 1. An apparatus for object detection, the apparatus comprising: at least one memory; and at least one processor coupled to the at least one memory and configured to: obtain, from a camera with a first view of a scene comprising one or more objects, a first image of the scene; determine, based on the first image, a first probability map comprising first probabilities of the one or more objects being located at locations within the scene; determine, based on the first image, a location of an item associated with each object of the one or more objects; map the item associated with each object of the one or more objects from the first view to a second view to produce a prior probability map associated with the second view; obtain, from the camera or another camera with the second view of the scene, a second image of the scene; determine, based on the second image, a second probability map comprising second probabilities of the one or more objects being located at the locations within the scene; blend the second probability map with the prior probability map to produce a blended probability map; and detect, based on the blended probability map, the one or more objects of the scene.

Aspect 2. The apparatus of Aspect 1, wherein the at least one processor is configured to blend the second probability map with the prior probability map based on a weighted sum of the second probability map and the prior probability map, a product of the second probability map and the prior probability map, a confidence preserve of the second probability map, or a prior boosting of the prior probability map.

Aspect 3. The apparatus of Aspect 2, wherein the blended probability map comprises the second probability map based on the blending being based on the confidence preserve of the second probability map and the second probability map having a confidence level greater than or equal to a confidence threshold.

Aspect 4. The apparatus of Aspect 2, wherein the blended probability map comprises a weighted sum of the prior probability map and the second probability map based on the blending being based on the confidence preserve of the prior probability map and the second probability map having a confidence level less than a confidence threshold.

Aspect 5. The apparatus of Aspect 2, wherein the blended probability map comprises a sum of the second probability map and a weighted prior probability map based on the blending being based on the prior boosting of the prior probability map.

Aspect 6. The apparatus of any of Aspects 1 to 5, wherein the at least one processor is configured to obtain the first image and the second image at a same time.

Aspect 7. The apparatus of any of Aspects 1 to 6, wherein the at least one processor is configured to obtain the first image at a first time and obtain the second image at a second time, wherein the first time is prior to the second time.

Aspect 8. The apparatus of any of Aspects 1 to 7, wherein the at least one processor is configured to map the item associated with each object of the one or more objects from the first view to the second view based on homography mapping.

Aspect 9. The apparatus of any of Aspects 1 to 8, wherein the first probability map and the second probability map are each a heatmap.

Aspect 10. The apparatus of any of Aspects 1 to 9, wherein the item associated with each object of the one or more objects is a foot.

Aspect 11. The apparatus of any of Aspects 1 to 10, wherein the at least one processor is configured to: determine, based on the second image, a location of the item associated with each object of the one or more objects; map the item associated with each object of the one or more objects from the second view to a first view to produce an additional prior probability map associated with the first view; blend the first probability map with the additional prior probability map to produce an additional blended probability map; and detect, based on the additional blended probability map, the one or more objects of the scene.

Aspect 12. A method for object detection, the method comprising: obtaining, by a camera with a first view of a scene comprising one or more objects, a first image of the scene; determining, based on the first image, a first probability map comprising first probabilities of the one or more objects being located at locations within the scene; determining, based on the first image, a location of an item associated with each object of the one or more objects; mapping the item associated with each object of the one or more objects from the first view to a second view to produce a prior probability map associated with the second view; obtaining, by the camera or another camera with the second view of the scene, a second image of the scene; determining, based on the second image, a second probability map comprising second probabilities of the one or more objects being located at the locations within the scene; blending the second probability map with the prior probability map to produce a blended probability map; and detecting, based on the blended probability map, the one or more objects of the scene.

Aspect 13. The method of Aspect 12, wherein blending the second probability map with the prior probability map is based on a weighted sum of the second probability map and the prior probability map, a product of the second probability map and the prior probability map, a confidence preserve of the second probability map, or a prior boosting of the prior probability map.

Aspect 14. The method of Aspect 13, wherein the blended probability map comprises the second probability map based on the blending being based on the confidence preserve of the second probability map and the second probability map having a confidence level greater than or equal to a confidence threshold.

Aspect 15. The method of Aspect 13, wherein the blended probability map comprises a weighted sum of the prior probability map and the second probability map based on the blending being based on the confidence preserve of the prior probability map and the second probability map having a confidence level less than a confidence threshold.

Aspect 16. The method of Aspect 13, wherein the blended probability map comprises a sum of the second probability map and a weighted prior probability map based on the blending being based on the prior boosting of the prior probability map.

Aspect 17. The method of any of Aspects 12 to 16, wherein the first image and the second image are obtained at a same time.

Aspect 18. The method of any of Aspects 12 to 17, wherein the first image is obtained at a first time, the second image is obtained at a second time, and the first time is prior to the second time.

Aspect 19. The method of any of Aspects 12 to 18, wherein mapping the item associated with each object of the one or more objects from the first view to the second view is based on homography mapping.

Aspect 20. The method of any of Aspects 12 to 19, wherein the first probability map and the second probability map are each a heatmap.

Aspect 21. The method of any of Aspects 12 to 20, wherein the item associated with each object of the one or more objects is a foot.

Aspect 22. The method of any of Aspects 12 to 21, further comprising: determining, based on the second image, a location of the item associated with each object of the one or more objects; mapping the item associated with each object of the one or more objects from the second view to a first view to produce an additional prior probability map associated with the first view; blending the first probability map with the additional prior probability map to produce an additional blended probability map; and detecting, based on the additional blended probability map, the one or more objects of the scene.

Aspect 23. A non-transitory computer-readable medium having stored thereon instructions that, when executed by at least one processor, cause the at least one processor to perform operations according to any of Aspects 12 to 22.

Aspect 24. An apparatus for object detection, the apparatus including one or more means for performing operations according to any of Aspects 12 to 22.

Aspect 25. An apparatus for object detection, the apparatus comprising: at least one memory; and at least one processor coupled to the at least one memory and configured to: obtain, by a tracker with a first view of a scene comprising one or more objects, a first probability map comprising first probabilities of the one or more objects being located at locations within the scene at a future time; determine, based on the first probability map, a location of an item associated with each object of the one or more objects; obtain, from a camera with the first view of the scene, an image of the scene at a current time; determine, based on the image, a second probability map comprising second probabilities of the one or more objects being located at the locations within the scene at the current time; blend the second probability map with the first probability map to produce a blended probability map; and detect, based on the blended probability map, the one or more objects of the scene.

Aspect 26. A method for object detection, the method comprising: obtaining, by a tracker with a first view of a scene comprising one or more objects, a first probability map comprising first probabilities of the one or more objects being located at locations within the scene at a future time; determining, based on the first probability map, a location of an item associated with each object of the one or more objects; obtaining, by a camera with the first view of the scene, an image of the scene at a current time; determining, based on the image, a second probability map comprising second probabilities of the one or more objects being located at the locations within the scene at the current time; blending the second probability map with the first probability map to produce a blended probability map; and detecting, based on the blended probability map, the one or more objects of the scene.

Aspect 27. A non-transitory computer-readable medium having stored thereon instructions that, when executed by at least one processor, cause the at least one processor to: obtain, by a tracker with a first view of a scene comprising one or more objects, a first probability map comprising first probabilities of the one or more objects being located at locations within the scene at a future time; determine, based on the first probability map, a location of an item associated with each object of the one or more objects; obtain, from a camera with the first view of the scene, an image of the scene at a current time; determine, based on the image, a second probability map comprising second probabilities of the one or more objects being located at the locations within the scene at the current time; blend the second probability map with the first probability map to produce a blended probability map; and detect, based on the blended probability map, the one or more objects of the scene.

Aspect 28. An apparatus for object detection, the apparatus including: means for obtaining, by a tracker with a first view of a scene comprising one or more objects, a first probability map comprising first probabilities of the one or more objects being located at locations within the scene at a future time; means for determining, based on the first probability map, a location of an item associated with each object of the one or more objects; means for obtaining, from a camera with the first view of the scene, an image of the scene at a current time; means for determining, based on the image, a second probability map comprising second probabilities of the one or more objects being located at the locations within the scene at the current time; means for blending the second probability map with the first probability map to produce a blended probability map; and means for detecting, based on the blended probability map, the one or more objects of the scene.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.”

What is claimed is:

1. An apparatus for object detection, the apparatus comprising:
at least one memory; and
at least one processor coupled to the at least one memory and configured to:
obtain, from a camera with a first view of a scene comprising one or more objects, a first image of the scene;
determine, based on the first image, a first probability map comprising first probabilities of the one or more objects being located at locations within the scene;
determine, based on the first image, a location of an item associated with each object of the one or more objects;
map the item associated with each object of the one or more objects from the first view to a second view to produce a prior probability map associated with the second view;
obtain, from the camera or another camera with the second view of the scene, a second image of the scene;
determine, based on the second image, a second probability map comprising second probabilities of the one or more objects being located at the locations within the scene;
blend the second probability map with the prior probability map to produce a blended probability map; and
detect, based on the blended probability map, the one or more objects of the scene.

2. The apparatus of claim 1, wherein the at least one processor is configured to blend the second probability map with the prior probability map based on a weighted sum of the second probability map and the prior probability map, a product of the second probability map and the prior probability map, a confidence preserve of the second probability map, or a prior boosting of the prior probability map.

3. The apparatus of claim 2, wherein the blended probability map comprises the second probability map based on the blending being based on the confidence preserve of the second probability map and the second probability map having a confidence level greater than or equal to a confidence threshold.

4. The apparatus of claim 2, wherein the blended probability map comprises a weighted sum of the prior probability map and the second probability map based on the blending being based on the confidence preserve of the prior probability map and the second probability map having a confidence level less than a confidence threshold.

5. The apparatus of claim 2, wherein the blended probability map comprises a sum of the second probability map and a weighted prior probability map based on the blending being based on the prior boosting of the prior probability map.

6. The apparatus of claim 1, wherein the at least one processor is configured to obtain the first image and the second image at a same time.

7. The apparatus of claim 1, wherein the at least one processor is configured to obtain the first image at a first time and obtain the second image at a second time, wherein the first time is prior to the second time.

8. The apparatus of claim 1, wherein the at least one processor is configured to map the item associated with each object of the one or more objects from the first view to the second view based on homography mapping.

9. The apparatus of claim 1, wherein the first probability map and the second probability map are each a heatmap.

10. The apparatus of claim 1, wherein the item associated with each object of the one or more objects is a foot.

11. The apparatus of claim 1, wherein the at least one processor is configured to:
determine, based on the second image, a location of the item associated with each object of the one or more objects;
map the item associated with each object of the one or more objects from the second view to a first view to produce an additional prior probability map associated with the first view;
blend the first probability map with the additional prior probability map to produce an additional blended probability map; and
detect, based on the additional blended probability map, the one or more objects of the scene.

12. A method for object detection, the method comprising:
obtaining, by a camera with a first view of a scene comprising one or more objects, a first image of the scene;
determining, based on the first image, a first probability map comprising first probabilities of the one or more objects being located at locations within the scene;
determining, based on the first image, a location of an item associated with each object of the one or more objects;
mapping the item associated with each object of the one or more objects from the first view to a second view to produce a prior probability map associated with the second view;
obtaining, by the camera or another camera with the second view of the scene, a second image of the scene;
determining, based on the second image, a second probability map comprising second probabilities of the one or more objects being located at the locations within the scene;
blending the second probability map with the prior probability map to produce a blended probability map; and
detecting, based on the blended probability map, the one or more objects of the scene.

13. The method of claim 12, wherein blending the second probability map with the prior probability map is based on a weighted sum of the second probability map and the prior probability map, a product of the second probability map and the prior probability map, a confidence preserve of the second probability map, or a prior boosting of the prior probability map.

14. The method of claim 13, wherein the blended probability map comprises the second probability map based on the blending being based on the confidence preserve of the second probability map and the second probability map having a confidence level greater than or equal to a confidence threshold.

15. The method of claim 13, wherein the blended probability map comprises a weighted sum of the prior probability map and the second probability map based on the blending being based on the confidence preserve of the prior probability map and the second probability map having a confidence level less than a confidence threshold.

16. The method of claim 13, wherein the blended probability map comprises a sum of the second probability map and a weighted prior probability map based on the blending being based on the prior boosting of the prior probability map.

17. The method of claim 12, wherein the first image and the second image are obtained at a same time.

18. The method of claim 12, wherein the first image is obtained at a first time, the second image is obtained at a second time, and the first time is prior to the second time.

19. The method of claim 12, wherein mapping the item associated with each object of the one or more objects from the first view to the second view is based on homography mapping.

20. The method of claim 12, wherein the first probability map and the second probability map are each a heatmap.
